(19) United States
(12) Patent Application Publication
(10) Pub. No.: US 2026/0329134 A1
(43) Pub. Date: Oct. 22, 2026

(54) BACKLIGHT CONTROL SYSTEMS INCLUDING BACKLIGHT DRIVER CHIPS WITH CONFIGURABLE COMMUNICATION PORTS AND METHODS THEREOF

(71) Applicant: ON-BRIGHT INTEGRATIONS CO., LTD., Shanghai (CN)

(72) Inventors: TUOFU LIU, Shanghai (CN); JUN ZHOU, Shanghai (CN); LIQIANG ZHU, Shanghai (CN)

(21) Appl. No.: 19/651,388

(22) Filed: Apr. 17, 2026

(30) Foreign Application Priority Data
Apr. 21, 2025 (CN) 202510502782.7

(51) Int. Cl. G02F 1/1335; G02F 1/13357

(52) U.S. Cl. CPC G02F 1/133612; G02F 1/133603

(57) ABSTRACT

Backlight driver chip for a backlight control system and method thereof. For example, a backlight driver chip for a backlight control system for light-emitting diodes includes: a first configurable communication port at a first voltage; a second configurable communication port at a second voltage; a first communication module connected to the first configurable communication port; a second communication module connected to the second configurable communication port; a first detection module connected to the first configurable communication port; a second detection module connected to the second configurable communication port; and a control module connected to the first communication module, the second communication module, the first detection module, and the second detection module; wherein: the first detection module is configured to determine whether the first voltage becomes larger than a first predetermined threshold or whether the first voltage becomes smaller than a second predetermined threshold to generate a first detection signal.

### 1. CROSS-REFERENCES TO RELATED APPLICATIONS

This application claims priority to Chinese Patent Application No. 202510502782.7, filed Apr. 21, 2025, incorporated by reference herein for all purposes.

### 2. FIELD OF THE DISCLOSURE

Certain embodiments of the present disclosure are directed to circuits. More particularly, some embodiments of the disclosure provide backlight driver chips with configurable communication ports. Merely by way of example, some embodiments of the disclosure have been applied to backlight control systems. But it would be recognized that the disclosure has a much broader range of applicability.

### 3. BACKGROUND OF THE DISCLOSURE

With the advancement of light-emitting diode (LED) display technology, Mini LED display devices are configured to separately adjust the brightness of different strings of Mini LEDs according to the content displayed on the screen to enhance image quality. Therefore, the Mini LED display devices have become increasingly popular.

FIG. 1 is a simplified diagram showing a conventional backlight control system for light-emitting diodes. As shown in FIG. 1, the conventional backlight control system 100 for light-emitting diodes includes a conventional backlight controller 102 and multiple conventional backlight driver chips. The multiple conventional backlight driver chips include conventional backlight driver chips 104-1, 104-2, . . . , and 104-q, where q is an integer greater than 1. Among the multiple conventional backlight driver chips, the conventional driver chip 104-1 is the most upstream driver chip, and the conventional driver chip 104-q is the most downstream driver chip.

Also as shown in FIG. 1, the backlight controller 102 and the multiple conventional backlight driver chips are cascaded (e.g., through a single-wire link), wherein the backlight controller 102 is connected to the most upstream driver chip 104-1 (e.g., through a signal wire), and every other driver chip that is not the most upstream driver chip 104-1 (e.g., the driver chip 104-2) of the multiple conventional backlight driver chips is connected to its immediate upstream driver chip (e.g., the driver chip 104-1) of the multiple conventional backlight driver chips (e.g., through a single wire).

In some examples, the multiple conventional backlight driver chips form a cascade of multiple conventional backlight driver chips by connecting the most upstream driver chip 104-1 to the backlight controller 102 (e.g., to the MOSI port of the backlight controller 102) and by connecting every other driver chip that is not the most upstream driver chip 104-1 to its immediate upstream driver chip. For example, the most downstream driver chip 104-q is connected to its immediate upstream driver chip 104-(q-1) and is also connected to the backlight controller 102 (e.g., to the MISO port of the backlight controller 102). As an example, the most downstream driver chip 104-q is connected to its immediate upstream driver chip 104-(q-1) but is not connected to the backlight controller 102.

Each conventional driver chip of the multiple conventional backlight driver chips includes two communication ports, wherein one communication port of the two communication ports is pre-configured to serve as a master communication port, not as a slave communication port, before the conventional driver chip is connected to the backlight controller 102 or another conventional driver chip, and the other communication port of the two communication ports is pre-configured to serve as a slave communication port, not as a master communication port, before the conventional driver chip is connected to the backlight controller 102 or another conventional driver chip.

For example, for the most upstream driver chip 104-1, its master communication port (e.g., communication port M) is connected to the backlight controller 102, and its slave communication port (e.g., communication port S) is connected to its immediate downstream driver chip 104-2. As an example, for each driver chip (e.g., the driver chip 104-2) that is not the most upstream driver chip 104-1, its master communication port (e.g., communication port M) is connected to its immediate upstream driver chip (e.g., the driver chip 104-1), and its slave communication port (e.g., communication port S) is connected to its immediate downstream driver chip 104-2.

In some examples, for the most upstream driver chip 104-1, its master communication port (e.g., communication port M) receives a control signal from the backlight controller 102, and its slave communication port (e.g., communication port S) outputs a control signal to its immediate downstream driver chip 104-2. For example, for the most upstream driver chip 104-1, its master communication port (e.g., communication port M) outputs a feedback signal to the backlight controller 102, and its slave communication port (e.g., communication port S) receives a feedback signal from its immediate downstream driver chip 104-2.

In certain examples, for each driver chip (e.g., the driver chip 104-2) that is not the most upstream driver chip 104-1, its master communication port (e.g., communication port M) receives a control signal from its immediate upstream driver chip (e.g., the driver chip 104-1), and its slave communication port (e.g., communication port S) outputs a control signal to its immediate downstream driver chip (e.g., the driver chip 104-3). As an example, for each driver chip (e.g., the driver chip 104-2) that is not the most upstream driver chip 104-1, its master communication port (e.g., communication port M) outputs a feedback signal to its immediate upstream driver chip (e.g., the driver chip 104-1), and its slave communication port (e.g., communication port S) receives a feedback signal from its immediate downstream driver chip (e.g., the driver chip 104-3).

As discussed above, for each conventional backlight driver chip, its master communication port (e.g., communication port M) and its slave communication port (e.g., communication port S) are pre-configured before the conventional backlight driver chip is connected to the backlight controller 102 or another conventional backlight driver chip, so in the conventional backlight driver chip, the positions of the master communication port (e.g., communication port M) and the slave communication port (e.g., communication port S) are fixed.

When wiring between conventional backlight driver chips, it is not always feasible to ensure that, for each conventional backlight driver chip, its master communication port, not its slave communication port, is closer to the slave communication port of its immediate upstream conventional backlight driver chip. As a result, it is often needed to rotate the orientation of one or more conventional backlight driver chips, change one or more wiring methods, and/or add one or more additional jumper wires (e.g., as shown in FIG. 2 and/or FIG. 3), thus increasing the wiring cost of the backlight control system and making its applications more difficult.

FIG. 2 is a simplified diagram showing a conventional backlight control system for light-emitting diodes. As shown in FIG. 2, the conventional backlight control system 200 for light-emitting diodes includes a conventional backlight controller 202 and multiple conventional backlight driver chips. The multiple conventional backlight driver chips include conventional backlight driver chips 204-1, 204-2, . . . , and 204-m, where m is an integer greater than 1. Among the multiple conventional backlight driver chips, the conventional driver chip 204-1 is the most upstream driver chip, and the conventional driver chip 204-m is the most downstream driver chip. The most upstream driver chip 204-1 is connected to the backlight controller 202 (e.g., to the MOSI port of the backlight controller 202), and every other driver chip that is not the most upstream driver chip 204-1 is connected to its immediate upstream driver chip. For example, the most downstream driver chip 204-m is connected to its immediate upstream driver chip 204-(m-1) and is also connected to the backlight controller 202 (e.g., to the MISO port of the backlight controller 202). As an example, the most downstream driver chip 204-m is connected to its immediate upstream driver chip 204-(m-1) but is not connected to the backlight controller 202.

FIG. 3 is a simplified diagram showing a conventional backlight control system for light-emitting diodes. As shown in FIG. 3, the conventional backlight control system 300 for light-emitting diodes includes a conventional backlight controller 302 and multiple conventional backlight driver chips. The multiple conventional backlight driver chips include conventional backlight driver chips 304-1, 304-2, . . . , and 304-r, where r is an integer greater than 1. Among the multiple conventional backlight driver chips, the conventional driver chip 304-1 is the most upstream driver chip, and the conventional driver chip 304-r is the most downstream driver chip. The most upstream driver chip 304-1 is connected to the backlight controller 302 (e.g., to the MOSI port of the backlight controller 302), and every other driver chip that is not the most upstream driver chip 304-1 is connected to its immediate upstream driver chip. For example, the most downstream driver chip 304-r is connected to its immediate upstream driver chip 304-(r-1) and is also connected to the backlight controller 302 (e.g., to the MISO port of the backlight controller 302). As an example, the most downstream driver chip 304-r is connected to its immediate upstream driver chip 304-(r-1) but is not connected to the backlight controller 302.

Hence it is highly desirable to improve the technique for backlight control systems including backlight driver chips.

### 4. BRIEF SUMMARY OF THE DISCLOSURE

Certain embodiments of the present disclosure are directed to circuits. More particularly, some embodiments of the disclosure provide backlight driver chips with configurable communication ports. Merely by way of example, some embodiments of the disclosure have been applied to backlight control systems. But it would be recognized that the disclosure has a much broader range of applicability.

According to some embodiments, a backlight driver chip for a backlight control system for light-emitting diodes includes: a first configurable communication port at a first voltage; a second configurable communication port at a second voltage; a first communication module connected to the first configurable communication port; a second communication module connected to the second configurable communication port; a first detection module connected to the first configurable communication port; a second detection module connected to the second configurable communication port; and a control module connected to the first communication module, the second communication module, the first detection module, and the second detection module; wherein: the first detection module is configured to determine whether the first voltage becomes larger than a first predetermined threshold or whether the first voltage becomes smaller than a second predetermined threshold to generate a first detection signal; and the second detection module is configured to determine whether the second voltage becomes larger than the first predetermined threshold or whether the second voltage becomes smaller than the second predetermined threshold to generate a second detection signal; wherein the control module is configured to: receive the first detection signal and the second detection signal; and determine one communication module of the first communication module and the second communication module to be a master communication module and the other communication module of the first communication module and the second communication module to be a slave communication module based at least in part on the first detection signal and the second detection signal.

According to certain embodiments, a method for a backlight driver chip, the method comprising: setting a first communication module to a signal input mode, the first communication module being connected to a first configurable communication port at a first voltage; setting a second communication module to the signal input mode, the second communication module being connected to a second configurable communication port at a second voltage; determining whether the first voltage becomes larger than a predetermined threshold to generate a first detection signal; determining whether the second voltage becomes larger than the predetermined threshold to generate a second detection signal; receiving the first detection signal and the second detection signal; determining the first communication module to be a master communication module and the second communication module to be a slave communication module if the first detection signal indicates that the first voltage becomes larger than the predetermined threshold; and determining the second communication module to be the master communication module and the first communication module to be the slave communication module if the second detection signal indicates that the second voltage becomes larger than the predetermined threshold.

According to some embodiments, a method for a backlight driver chip, the method comprising: setting a first communication module to a signal input mode, the first communication module being connected to a first configurable communication port at a first voltage; setting a second communication module to the signal input mode, the second communication module being connected to a second configurable communication port at a second voltage; determining whether the first voltage becomes smaller than a predetermined threshold to generate a first detection signal; determining whether the second voltage becomes smaller than the predetermined threshold to generate a second detection signal; receiving the first detection signal and the second detection signal; determining the first communication module to be a master communication module and the second communication module to be a slave communication module if the first detection signal indicates that the first voltage becomes smaller than the predetermined threshold; and determining the second communication module to be the master communication module and the first communication module to be the slave communication module if the second detection signal indicates that the second voltage becomes smaller than the predetermined threshold.

According to certain embodiments, a backlight control system for light-emitting diodes includes: a backlight controller including a first controller port and a second controller port; a first backlight driver chip including a first configurable communication port at a first voltage and a second configurable communication port at a second voltage; and a second backlight driver chip including a third configurable communication port at a third voltage and a fourth configurable communication port at a fourth voltage; wherein: the first controller port is connected to the first configurable communication port of the first backlight driver chip; and the second configurable communication port of the first backlight driver chip is connected to the third configurable communication port of the second backlight driver chip; wherein the first backlight driver chip is configured to: receive, at the first configurable communication port, a first external pull-up signal to cause the first voltage to rise; determine whether the first voltage becomes larger than a predetermined threshold; if the first voltage becomes larger than the predetermined threshold, determine the first configurable communication port to be a first master communication port and the second configurable communication port to be a first slave communication port; and output, at the second configurable communication port, a second external pull-up signal; wherein the second backlight driver chip is configured to: receive, at the third configurable communication port, the second external pull-up signal to cause the third voltage to rise; determine whether the third voltage becomes larger than the predetermined threshold; and if the third voltage becomes larger than the predetermined threshold, determine the third configurable communication port to be a second master communication port and the fourth configurable communication port to be a second slave communication port.

According to some embodiments, a backlight control system for light-emitting diodes includes: a backlight controller including a first controller port and a second controller port; a first backlight driver chip including a first configurable communication port at a first voltage and a second configurable communication port at a second voltage; and a second backlight driver chip including a third configurable communication port at a third voltage and a fourth configurable communication port at a fourth voltage; wherein: the first controller port is connected to the first configurable communication port of the first backlight driver chip; and the second configurable communication port of the first backlight driver chip is connected to the third configurable communication port of the second backlight driver chip; wherein the first backlight driver chip is configured to: receive, at the first configurable communication port, a first external pull-down signal to cause the first voltage to fall; determine whether the first voltage becomes smaller than a predetermined threshold; if the first voltage becomes smaller than the predetermined threshold, determine the first configurable communication port to be a first master communication port and the second configurable communication port to be a first slave communication port; and output, at the second configurable communication port, a second external pull-down signal; wherein the second backlight driver chip is configured to: receive, at the third configurable communication port, the second external pull-down signal to cause the third voltage to fall; determine whether the third voltage becomes smaller than the predetermined threshold; and if the third voltage becomes smaller than the predetermined threshold, determine the third configurable communication port to be a second master communication port and the fourth configurable communication port to be a second slave communication port.

According to certain embodiments, a method for a backlight control system for light-emitting diodes, the backlight control system including a backlight controller including a first controller port and a second controller port, a first backlight driver chip including a first configurable communication port and a second configurable communication port, and a second backlight driver chip including a third configurable communication port and a fourth configurable communication port, the first controller port being connected to the first configurable communication port, the second configurable communication port being connected to the third configurable communication port, the method comprising: receiving, at the first configurable communication port, a first external pull-up signal to cause a first voltage of the first configurable communication port to rise; determining whether the first voltage becomes larger than a predetermined threshold; if the first voltage becomes larger than the predetermined threshold, determining the first configurable communication port to be a first master communication port and the second configurable communication port to be a first slave communication port; and outputting, at the second configurable communication port, a second external pull-up signal; receiving, at the third configurable communication port, the second external pull-up signal to cause a second voltage of the third configurable communication port to rise; determining whether the second voltage becomes larger than the predetermined threshold; and if the second voltage becomes larger than the predetermined threshold, determining the third configurable communication port to be a second master communication port and the fourth configurable communication port to be a second slave communication port.

According to some embodiments, a method for a backlight control system for light-emitting diodes, the backlight control system including a backlight controller including a first controller port and a second controller port, a first backlight driver chip including a first configurable communication port and a second configurable communication port, and a second backlight driver chip including a third configurable communication port and a fourth configurable communication port, the first controller port being connected to the first configurable communication port, the second configurable communication port being connected to the third configurable communication port, the method comprising: receiving, at the first configurable communication port, a first external pull-down signal to cause a first voltage of the first configurable communication port to fall; determining whether the first voltage becomes smaller than a predetermined threshold; if the first voltage becomes smaller than the predetermined threshold, determining the first configurable communication port to be a first master communication port and the second configurable communication port to be a first slave communication port; and outputting, at the second configurable communication port, a second external pull-down signal; receiving, at the third configurable communication port, the second external pull-down signal to cause a second voltage of the third configurable communication port to fall; determining whether the second voltage becomes smaller than the predetermined threshold; and if the second voltage becomes smaller than the predetermined threshold, determining the third configurable communication port to be a second master communication port and the fourth configurable communication port to be a second slave communication port.

Depending upon embodiment, one or more benefits may be achieved. These benefits and various additional objects, features and advantages of the present disclosure can be fully appreciated with reference to the detailed description and accompanying drawings that follow.

### 5. BRIEF DESCRIPTION OF THE DRAWINGS

FIG. 1 is a simplified diagram showing a conventional backlight control system for light-emitting diodes.

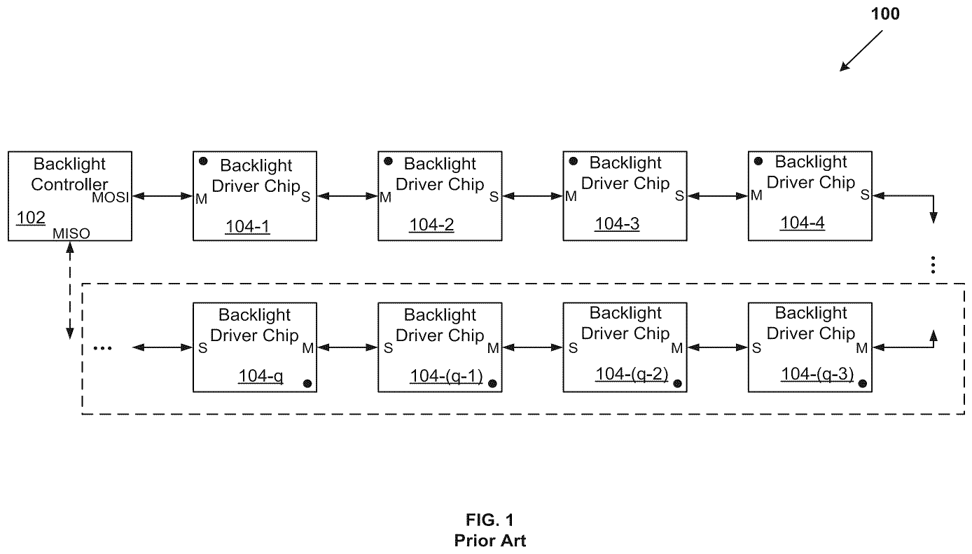

FIG. 2 is a simplified diagram showing a conventional backlight control system for light-emitting diodes.

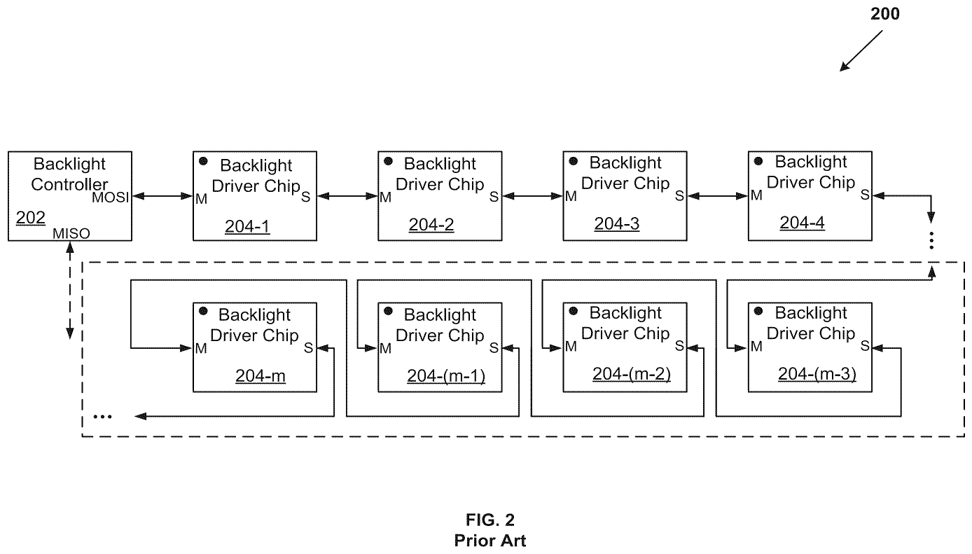

FIG. 3 is a simplified diagram showing a conventional backlight control system for light-emitting diodes.

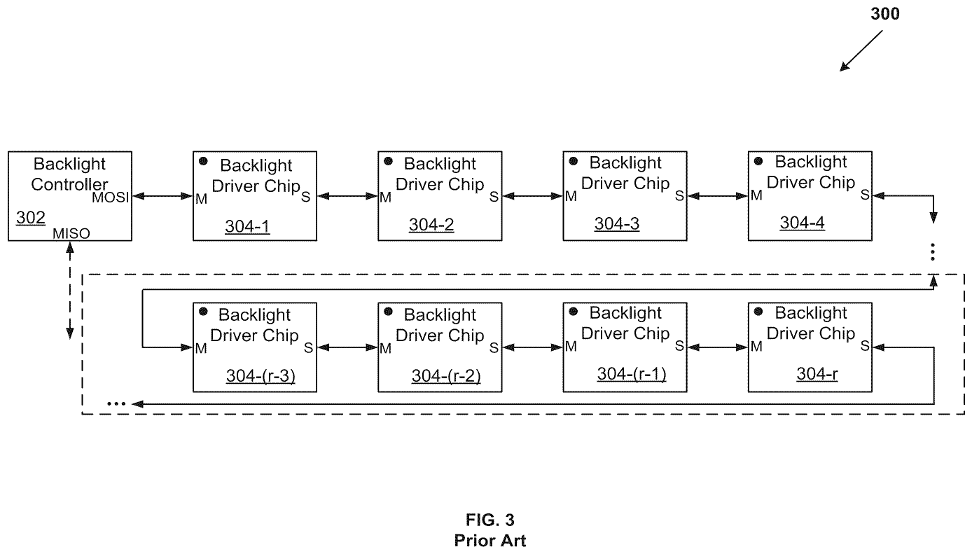

FIG. 4 is a simplified diagram showing a backlight driver chip with configurable communication ports according to certain embodiments of the present disclosure.

FIG. 5 is a simplified diagram showing a communication module as part of the backlight driver chip as shown in FIG. 4 according to some embodiments of the present disclosure.

FIG. 6 is a simplified diagram showing a detection module as part of the backlight driver chip as shown in FIG. 4 according to some embodiments of the present disclosure.

FIG. 7 shows simplified timing diagrams for the detection module as part of the backlight driver chip as shown in FIG. 4 and FIG. 6 according to some embodiments of the present disclosure.

FIG. 8 is a simplified diagram showing a detection module as part of the backlight driver chip as shown in FIG. 4 according to certain embodiments of the present disclosure.

FIG. 9 shows simplified timing diagrams for the detection module as part of the backlight driver chip as shown in FIG. 4 and FIG. 8 according to certain embodiments of the present disclosure.

FIG. 10 is a simplified diagram showing a detection module as part of the backlight driver chip as shown in FIG. 4 according to some embodiments of the present disclosure.

FIG. 11 is a simplified diagram showing a detection module as part of the backlight driver chip as shown in FIG. 4 according to certain embodiments of the present disclosure.

FIG. 12 is a simplified diagram showing a method for setting up the communication modules of the backlight driver chip with configurable communication ports as shown in FIG. 4 according to certain embodiments of the present disclosure.

FIG. 13 is a simplified diagram showing a backlight control system for light-emitting diodes that includes multiple backlight driver chips as shown in FIG. 4 according to some embodiments of the present disclosure.

FIG. 14 shows simplified timing diagrams for the backlight control system for light-emitting diodes that includes multiple backlight driver chips as shown in FIG. 4 and FIG. 13 according to some embodiments of the present disclosure.

FIG. 15 shows simplified timing diagrams for the backlight control system for light-emitting diodes that includes multiple backlight driver chips as shown in FIG. 4 and FIG. 13 according to certain embodiments of the present disclosure.

### 6. DETAILED DESCRIPTION OF THE DISCLOSURE

Certain embodiments of the present disclosure are directed to circuits. More particularly, some embodiments of the disclosure provide backlight driver chips with configurable communication ports. Merely by way of example, some embodiments of the disclosure have been applied to backlight control systems. But it would be recognized that the disclosure has a much broader range of applicability.

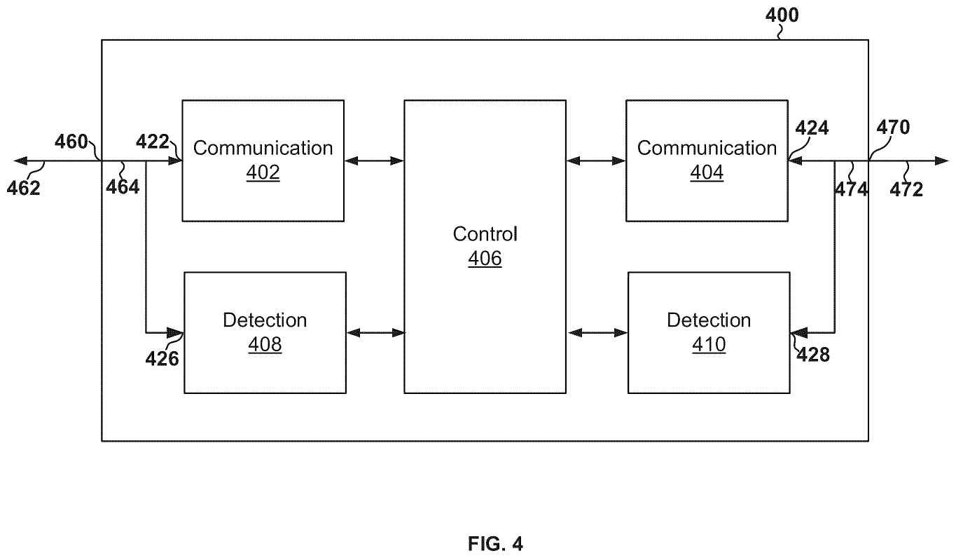

FIG. 4 is a simplified diagram showing a backlight driver chip with configurable communication ports according to certain embodiments of the present disclosure. This diagram is merely an example, which should not unduly limit the scope of the claims. One of ordinary skill in the art would recognize many variations, alternatives, and modifications. The backlight driver chip 400 includes configurable communication ports 460 and 470, communication modules 402 and 404, detection modules 408 and 410, and a control module 406. For example, the configurable communication port 460 is connected to the communication module 402 and the detection module 408. As an example, the configurable communication port 470 is connected to the communication module 404 and the detection module 410. In some examples, the communication module 402 includes a terminal 422 connected to the configurable communication port 460, and the communication module 404 includes a terminal 424 connected to the configurable communication port 470. For example, the configurable communication port 460 is at a voltage 464. As an example, the configurable communication port 470 is at a voltage 474. In certain examples, the detection module 408 includes a terminal 426 connected to the configurable communication port 460, and the detection module 410 includes a terminal 428 connected to the configurable communication port 470. For example, the terminal 426 receives the voltage 464 of the configurable communication port 460. As an example, the terminal 428 receives the voltage 474 of the configurable communication port 470. Although the above has been shown using a selected group of components for the backlight driver chip, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In some examples, the communication module 402 is a bidirectional communication module that are configured to operate in a signal input mode and/or in a signal output mode. For example, in the signal input mode, the terminal 422 of the communication module 402 receives a signal through the configurable communication port 460. As an example, in the signal output mode, the terminal 422 of the communication module 402 outputs a signal through the configurable communication port 460.

In certain examples, the communication module 404 is a bidirectional communication module that are configured to operate in a signal input mode and/or in a signal output mode. For example, in the signal input mode, the terminal 424 of the communication module 404 receives a signal through the configurable communication port 470. As an example, in the signal output mode, the terminal 424 of the communication module 404 outputs a signal through the configurable communication port 470.

According to some embodiments, the control module 406 is configured to set the communication module 402 to the signal input mode and also set the communication module 404 to the signal input mode. In certain examples, in the signal input mode, the communication module 402 receives the voltage 464 of the configurable communication port 460, which is also received by the terminal 426 of the detection module 408. For example, the configurable communication port 460 receives an external signal 462, which causes the voltage 464 to change. As an example, the detection module 408 detects the voltage 464 and determines whether the voltage 464 changes from being smaller than a predetermined threshold to being larger than the predetermined threshold or whether the voltage 464 changes from being larger than a predetermined threshold to being smaller than the predetermined threshold. In some examples, in the signal input mode, the communication module 404 receives the voltage 474 of the configurable communication port 470, which is also received by the terminal 428 of the detection module 410. For example, the configurable communication port 470 receives an external signal 472, which causes the voltage 474 to change. As an example, the detection module 410 detects the voltage 474 and determines whether the voltage 474 changes from being smaller than a predetermined threshold to being larger than the predetermined threshold or whether the voltage 474 changes from being larger than a predetermined threshold to being smaller than the predetermined threshold.

In certain embodiments, if the detection module 408 determines that the voltage 464 becomes larger than a predetermined threshold (e.g., changing from being smaller than the predetermined threshold to being larger than the predetermined threshold) or determines that the voltage 464 becomes smaller than a predetermined threshold (e.g., changing from being larger than the predetermined threshold to being smaller than the predetermined threshold), the control module 406 designates the configurable communication port 460 as a master communication port and the communication module 402 as a master communication module. For example, if the backlight driver chip 400 is not the first backlight driver chip in a cascade of multiple backlight driver chips, the configurable communication port 460 as the master communication port is connected to an immediate upstream backlight driver chip. As an example, if the backlight driver chip 400 is the first backlight driver chip in the cascade, the configurable communication port 460 as the master communication port is connected to a backlight controller that is connected to the cascade of multiple backlight driver chips. In some examples, if the detection module 408 determines that the strength of the external signal 462 exceeds a predetermined strength threshold, the control module 406 also designates the configurable communication port 470 as a slave communication port and the communication module 404 as a slave communication module. For example, if the backlight driver chip 400 is not the last backlight driver chip in the cascade of multiple backlight driver chips, the configurable communication port 470 as a slave communication port is connected to an immediate downstream backlight driver chip. As an example, if the backlight driver chip 400 is the last backlight driver chip in the cascade, the configurable communication port 470 as a slave communication port is either connected to the backlight controller or not connected to the backlight controller.

In some embodiments, if the detection module 410 determines that the voltage 474 becomes larger than a predetermined threshold (e.g., changing from being smaller than the predetermined threshold to being larger than the predetermined threshold) or determines that the voltage 474 becomes smaller than a predetermined threshold (e.g., changing from being larger than the predetermined threshold to being smaller than the predetermined threshold), the control module 406 designates the configurable communication port 470 as a master communication port and the communication module 404 as a master communication module. For example, if the backlight driver chip 400 is not the first backlight driver chip in the cascade of multiple backlight driver chips, the configurable communication port 470 as the master communication port is connected to an immediate upstream backlight driver chip. As an example, if the backlight driver chip 400 is the first backlight driver chip in the cascade, the configurable communication port 470 as the master communication port is connected to the backlight controller. In some examples, if the detection module 410 determines that the strength of the external signal 472 exceeds a predetermined strength threshold, the control module 406 also designates the configurable communication port 460 as a slave communication port and the communication module 402 as a slave communication module. For example, if the backlight driver chip 400 is not the last backlight driver chip in the cascade of multiple backlight driver chips, the configurable communication port 460 as a slave communication port is connected to an immediate downstream backlight driver chip. As an example, if the backlight driver chip 400 is the last backlight driver chip in the cascade, the configurable communication port 460 as a slave communication port is either connected to the backlight controller or not connected to the backlight controller.

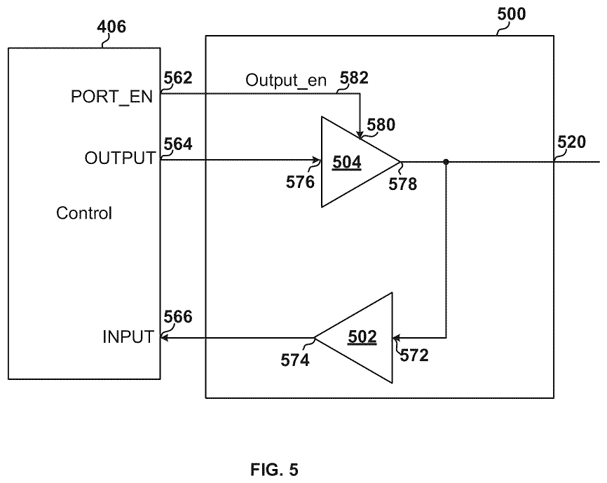

FIG. 5 is a simplified diagram showing a communication module as part of the backlight driver chip 400 as shown in FIG. 4 according to some embodiments of the present disclosure. This diagram is merely an example, which should not unduly limit the scope of the claims. One of ordinary skill in the art would recognize many variations, alternatives, and modifications. The communication module 500 includes a terminal 520 (e.g., a communication port IO), a signal input path 502 and a signal output path 504. For example, the communication module 500 is the communication module 402, wherein the terminal 520 is the terminal 422 connected to the configurable communication port 460. As an example, the communication module 500 is the communication module 404, wherein the terminal 520 is the terminal 424 connected to the configurable communication port 470. Although the above has been shown using a selected group of components for the communication module, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

As shown in FIG. 5, the signal input path 502 are connected between the control module 406 and the terminal 520, and the signal output path 504 are also connected between the control module 406 and the terminal 520 according to certain embodiments. For example, the signal input path 502 are connected between the control module 406 and the configurable communication port 460, and the signal output path 504 are also connected between the control module 406 and the configurable communication port 460. As an example, the signal input path 502 are connected between the control module 406 and the configurable communication port 470, and the signal output path 504 are also connected between the control module 406 and the configurable communication port 470. In some embodiments, the control module 406 includes terminals 562, 564, and 566. For example, the terminals 562 and 564 are connected to the signal output path 504 of the communication module 500. As an example, the terminal 520 is connected to the signal input path 502 of the communication module 500.

According to some embodiments, if the signal output path 504 is enabled (e.g., being active), the communication module 500 operates in a signal output mode, and if the signal output path 504 is disabled (e.g., being inactive), the communication module 500 operates in a signal input mode. In certain examples, in the signal input mode, the communication module 500 receives an external signal (e.g., the external signal 462 and/or the external signal 472) at the terminal 520 (e.g., a communication port IO), wherein the received signal is processed by the signal input path 502, and the processed signal is sent to the terminal 566 of the control module 406. In some examples, in the signal output mode, the communication module 500 receives a signal from the terminal 564 of the control module 406, wherein the received signal is processed by the signal output path 504, and the processed signal is sent to the terminal 520 (e.g., a communication port IO).

In certain embodiments, the signal input path 502 is a buffer, wherein the buffer 502 includes an input terminal 572 connected to the terminal 520 (e.g., a communication port IO) and also includes an output terminal 574 connected to the terminal 566 of the control module 406. In some embodiments, the signal output path 504 is a buffer, wherein the buffer 504 includes an input terminal 576, an output terminal 578, and an enable terminal 580. For example, the input terminal 576 is connected to the terminal 564 of the control module 406, and the output terminal 578 is connected to the terminal 520 (e.g., a communication port IO). As an example, the enable terminal 580 is connected to the terminal 562 of the control module 406. In certain examples, the enable terminal 580 receives a signal 582 from the terminal 562 of the control module 406. For example, if the signal 582 is in an enable state, the signal output path 504 (e.g., the buffer 504) is enabled (e.g., being active) and the communication module 500 operates in a signal output mode. As an example, if the signal 582 is in a disable state, the signal output path 504 (e.g., the buffer 504) is disabled (e.g., being inactive) and the communication module 500 operates in a signal input mode, wherein for example, the terminal 520 (e.g., a communication port IO) is in a high-impedance state.

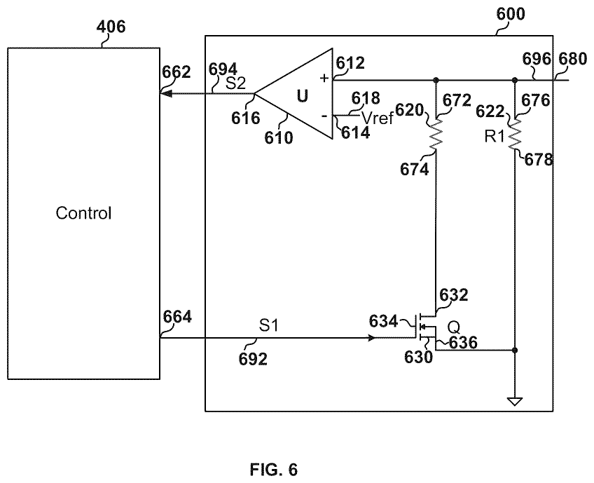

FIG. 6 is a simplified diagram showing a detection module as part of the backlight driver chip 400 as shown in FIG. 4 according to some embodiments of the present disclosure. This diagram is merely an example, which should not unduly limit the scope of the claims.

One of ordinary skill in the art would recognize many variations, alternatives, and modifications. The detection module 600 includes a terminal 680 (e.g., a communication port IO), a comparator 610, resistors 620 and 622, and a switch 630. For example, the detection module 600 is the detection module 408, wherein the terminal 680 is the terminal 426 connected to the configurable communication port 460. As an example, the detection module 600 is the detection module 410, wherein the terminal 680 is the terminal 428 connected to the configurable communication port 470. In some examples, the resistor 620 is a circuit element that serves as a port bias resistor if the switch 630 is closed. In certain examples, the switch 630 is a transistor (e.g., an NMOS transistor). Although the above has been shown using a selected group of components for the detection module, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to certain embodiments, the resistor 622 includes terminals 676 and 678, wherein the terminal 676 is connected to the terminal 680 (e.g., a communication port IO), and the terminal 678 is biased to a ground voltage. In some examples, the terminal 680 (e.g., a communication port IO) is at a voltage 696. For example, the detection module 600 is the detection module 408, wherein the terminal 680 is the terminal 426, and the voltage 696 is the voltage 464. As an example, the detection module 600 is the detection module 410, wherein the terminal 680 is the terminal 428, and the voltage 696 is the voltage 474.

In some embodiments, the resistor 620 and the switch 630 (e.g., a transistor) are connected in series between the terminals 676 and 678 of the resistor 622. For example, the resistor 620 includes terminals 672 and 674, wherein the terminal 672 is connected to the terminal 680 (e.g., a communication port IO). As an example, the resistance of the resistor 620 is much smaller than the resistance of the resistor 622. In certain examples, the transistor 630 (e.g., an NMOS transistor) includes terminals 632, 634, and 636, wherein the terminal 632 is connected to the terminal 674 of the resistor 620, and the terminal 636 is biased to the ground voltage. In some examples, the comparator 610 includes terminals 612, 614, and 616, wherein the terminal 612 is a non-inverting input terminal, the terminal 614 is an inverting input terminal, and the terminal 616 is an output terminal. For example, the terminal 612 is connected to the terminal 680 (e.g., a communication port IO). As an example, the terminal 614 receives a reference voltage 618 (e.g., Vref_{ref}), which represents a predetermined threshold. For example, the reference voltage 618 (e.g., Vref_{ref}) is higher than the ground voltage.

In certain embodiments, the control module 406 includes terminals 662 and 664. For example, the terminal 664 of the control module 406 outputs a signal 692 to the terminal 634 of the transistor 630. As an example, the terminal 662 of the control module 406 receives a signal 694 (e.g., a detection signal) from the terminal 616 of the comparator 610, wherein the signal 694 represents a detection result of the detection module 600.

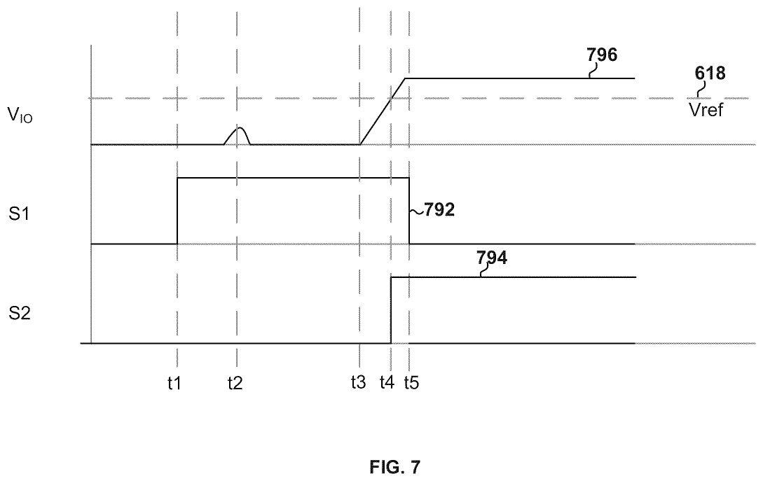

FIG. 7 shows simplified timing diagrams for the detection module 600 as part of the backlight driver chip 400 as shown in FIG. 4 and FIG. 6 according to some embodiments of the present disclosure. These diagrams are merely examples, which should not unduly limit the scope of the claims. One of ordinary skill in the art would recognize many variations, alternatives, and modifications. The waveform 796 represents the voltage 696 of the terminal 680 (e.g., a communication port IO) as a function of time, the waveform 792 represents the signal 692 as a function of time, and the waveform 794 represents the signal 694 (e.g., a detection signal) as a function of time.

At time t₁, the backlight driver chip 400 has been powered on, and the control module 406 of the backlight driver chip 400 sets both the communication module 402 and the communication module 404 to a signal input mode to start a detection period of the detection module 600 according to certain embodiments. For example, at time t₁, the control module 406 of the backlight driver chip 400 changes the signal 692 from a logic low level to a logic high level to close the switch 630 (e.g., to turn on the transistor 630) as shown by the waveform 792. As an example, at time t₁, the backlight driver chip 400 is powered on, and time t₁ is the start of the detection period during which the detection module 600 performs detection. In some examples, at time t₁, the terminal 680 (e.g., a communication port IO) does not receive any external pull-up signal, and the voltage 696 is equal to the ground voltage as shown by the waveform 796. In certain examples, at time t₁, the signal 694 (e.g., a detection signal) that is generated by the comparator 610 is at the logic low level, indicating the voltage 696 is lower than the reference voltage 618 (e.g., Vref_{ref}), as shown by the waveforms 794 and 796.

From time t₁ to time t₃, the signal 692 remains at the logic high level as shown by the waveform 792 and the switch 630 remains closed (e.g., the transistor 630 remains turned on) according to certain embodiments. For example, from time t₁ to time t₃, the voltage 696 remains lower than the reference voltage 618 (e.g., Vref_{ref}) as shown by the waveform 796. As an example, from time t₁ to time t₃, the signal 694 (e.g., a detection signal) remains at the logic low level as shown by the waveform 794. In some examples, time t₂ falls between time t₁ and time t₃, following time t₁ but preceding time t₃. For example, at time t₂, the terminal 680 (e.g., a communication port IO) receives an external pull-up signal (e.g., the external pull-up noise signal 462 or the external pull-up noise signal 472), and the voltage 696 is larger than the ground voltage but is still lower than the reference voltage 618 (e.g., Vref_{ref}) as shown by the waveform 796. As an example, at time t₂, the signal 694 (e.g., a detection signal) is at the logic low level as shown by the waveform 794.

At time t₃, the terminal 680 (e.g., a communication port IO) receives an external pull-up signal (e.g., the external pull-up signal 462 or 472, which is used to initiate normal operation of the backlight driver chip 400), and the voltage 696 starts increasing (e.g., rising) but is still lower than the reference voltage 618 (e.g., Vref_{ref}) as shown by the waveform 796 according to some embodiments. For example, at time t₃, the signal 692 remains at the logic high level as shown by the waveform 792. As an example, at time t₃, the signal 694 (e.g., a detection signal) is still at the logic low level as shown by the waveform 794.

From time t₃ to time t₄, the terminal 680 (e.g., a communication port IO) receives the external pull-up signal (e.g., the external pull-up signal 462 or 472, which is used to initiate normal operation of the backlight driver chip 400), and the voltage 696 rises but still remains lower than the reference voltage 618 (e.g., Vref_{ref}) as shown by the waveform 796 according to certain embodiments. For example, from time t₃ to time t₄, the signal 692 remains at the logic high level as shown by the waveform 792. As an example, from time t₃ to time t₄, the signal 694 (e.g., a detection signal) remains at the logic low level as shown by the waveform 794.

At time t₄, the terminal 680 (e.g., a communication port IO) receives the external pull-up signal (e.g., the external pull-up signal 462 or 472, which is used to initiate normal operation of the backlight driver chip 400), and the voltage 696 becomes larger than the reference voltage 618 (e.g., Vref_{ref}) as shown by the waveform 796 according to some embodiments. In certain examples, at time t₄, the signal 692 remains at the logic high level as shown by the waveform 792. In some examples, at time t₄, the signal 694 (e.g., a detection signal) changes from the logic low level to a logic high level as shown by the waveform 794. For example, the detection module 600 is the detection module 408, and at time t₄, the signal 694 (e.g., a detection signal) of the detection module 408 change from the logic low level to the logic high level. As an example, the detection module 600 is the detection module 410, and at time t₄, the signal 694 (e.g., a detection signal) of the detection module 410 changes from the logic low level to the logic high level.

From time t₄ to time t₅, the terminal 680 (e.g., a communication port IO) receives the external pull-up signal (e.g., the external pull-up signal 462 or 472, which is used to initiate normal operation of the backlight driver chip 400), and the voltage 696 increases from the reference voltage 618 (e.g., Vref_{ref}) as shown by the waveform 796 according to certain embodiments. For example, from time t₄ to time t₅, the signal 692 remains at the logic high level as shown by the waveform 792. As an example, from time t₄ to time t₅, the signal 694 (e.g., a detection signal) remains at the logic high level as shown by the waveform 794. In some examples, if at time t₄, the signal 694 (e.g., a detection signal) of the detection module 408 changes from the logic low level to the logic high level, the control module 406, at a time between time t₄ to time t₅, sets the configurable communication port 460 as a master communication port and the communication module 402 as a master communication module and also sets the configurable communication port 470 as a slave communication port and the communication module 404 as a slave communication module. In certain examples, if at time t₄ , the signal 694 (e.g., a detection signal) of the detection module 410 changes from the logic low level to the logic high level, the control module 406, at a time between time t₄to time t₅, sets the configurable communication port 470 as a master communication port and the communication module 404 as a master communication module and also sets the configurable communication port 460 as a slave communication port and the communication module 402 as a slave communication module.

At time t₅, the terminal 680 (e.g., a communication port IO) receives the external pull-up signal (e.g., the external pull-up signal 462 or 472, which is used to initiate normal operation of the backlight driver chip 400), and the voltage 696 reaches a predetermined high voltage level that is higher than the reference voltage 618 (e.g., Vref_{ref}) as shown by the waveform 796 according to some embodiments. In certain examples, at time t₅, the signal 792 changes from the logic high level to the logic low level to open the switch 630 (e.g., to turn off the transistor 630) as shown by the waveform 792. For example, time t₅ is the end of the detection period of the detection module 600, during which the detection module 600 performs detection. As an example, time t₅ is the start of normal operation of the backlight driver chip 400. In some examples, at time t₅, the signal 694 (e.g., a detection signal) remains at the logic high level as shown by the waveform 794.

After time t₅, the voltage 696 remains at the predetermined high voltage level that is higher than the reference voltage 618 (e.g., Vref_{ref}) as shown by the waveform 796 according to certain embodiments. In some examples, after time t₅, the signal 792 remains at the logic low level as shown by the waveform 792, and the switch 630 remains open (e.g., the transistor 630 remains turned off). For example, after time t₅, the detection module 600 does not perform detection. As an example, after time t₅, the backlight driver chip 400 that includes the detection module 600 undergoes normal operation. In some examples, after time t₅, the signal 694 (e.g., a detection signal) remains at the logic high level as shown by the waveform 794.

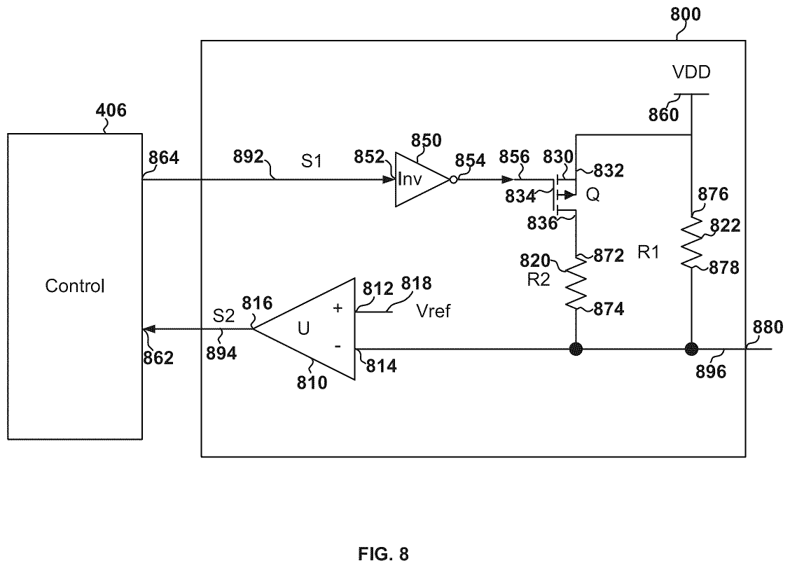

FIG. 8 is a simplified diagram showing a detection module as part of the backlight driver chip 400 as shown in FIG. 4 according to certain embodiments of the present disclosure. This diagram is merely an example, which should not unduly limit the scope of the claims. One of ordinary skill in the art would recognize many variations, alternatives, and modifications. The detection module 800 includes a terminal 880 (e.g., a communication port IO), a comparator 810, resistors 820 and 822, a switch 830, and an inverter 850 (e.g., a NOT gate). For example, the detection module 800 is the detection module 408, wherein the terminal 880 is the terminal 426 connected to the configurable communication port 460. As an example, the detection module 800 is the detection module 410, wherein the terminal 880 is the terminal 428 connected to the configurable communication port 470. In some examples, the resistor 820 is a circuit element that serves as a port bias resistor if the switch 830 is closed. In certain examples, the switch 830 is a transistor (e.g., a PMOS transistor). Although the above has been shown using a selected group of components for the detection module, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to some embodiments, the resistor 822 includes terminals 876 and 878, wherein the terminal 878 is connected to the terminal 880 (e.g., a communication port IO), and the terminal 876 is biased to a predetermined power supply voltage 860. In certain examples, the terminal 880 (e.g., a communication port IO) is at a voltage 896. For example, the detection module 800 is the detection module 408, wherein the terminal 880 is the terminal 426, and the voltage 896 is the voltage 464. As an example, the detection module 800 is the detection module 410, wherein the terminal 880 is the terminal 428, and the voltage 896 is the voltage 474.

In certain embodiments, the resistor 820 and the switch 830 (e.g., a transistor) are connected in series between the terminals 876 and 878 of the resistor 622. For example, the resistor 820 includes terminals 872 and 874, wherein the terminal 874 is connected to the terminal 880 (e.g., a communication port IO). As an example, the resistance of the resistor 820 is much smaller than the resistance of the resistor 822. In some examples, the transistor 830 (e.g., a PMOS transistor) includes terminals 832, 834, and 836, wherein the terminal 836 is connected to the terminal 872 of the resistor 820, and the terminal 832 is biased to the predetermined power supply voltage 860. In certain examples, the comparator 810 includes terminals 812, 814, and 816, wherein the terminal 812 is a non-inverting input terminal, the terminal 814 is an inverting input terminal, and the terminal 816 is an output terminal. For example, the terminal 814 is connected to the terminal 880 (e.g., a communication port IO). As an example, the terminal 812 receives a reference voltage 818 (e.g., Vref_{ref}), which represents a predetermined threshold. For example, the reference voltage 818 (e.g., Vref_{ref}) is lower than the predetermined power supply voltage 860.

In some embodiments, the control module 406 includes terminals 862 and 864, and the inverter 850 (e.g., a NOT gate) includes an input terminal 852 and an output terminal 854. For example, the terminal 864 of the control module 406 outputs a signal 892 to the terminal 852 of the inverter 850 (e.g., a NOT gate), and the inverter 850 (e.g., a NOT gate) generates a signal 856 and outputs the signal 856 to the terminal 834 of the transistor 830. As an example, the terminal 862 of the control module 406 receives a signal 894 (e.g., a detection signal) from the terminal 816 of the comparator 810, wherein the signal 894 represents a detection result of the detection module 800.

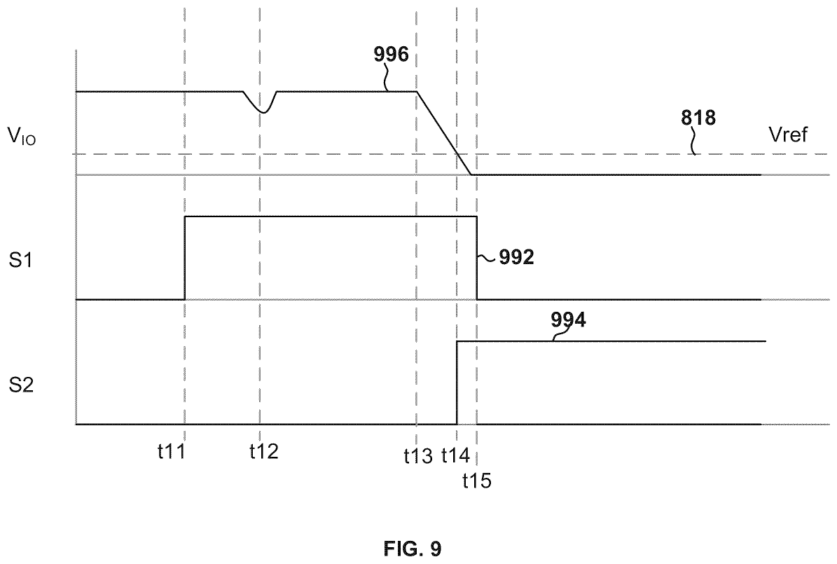

FIG. 9 shows simplified timing diagrams for the detection module 800 as part of the backlight driver chip 400 as shown in FIG. 4 and FIG. 8 according to certain embodiments of the present disclosure. These diagrams are merely examples, which should not unduly limit the scope of the claims. One of ordinary skill in the art would recognize many variations, alternatives, and modifications. The waveform 996 represents the voltage 896 of the terminal 880 (e.g., a communication port IO) as a function of time, the waveform 992 represents the signal 892 as a function of time, and the waveform 994 represents the signal 894 (e.g., a detection signal) as a function of time.

At time t₁₁, the backlight driver chip 400 has been powered on, and the control module 406 of the backlight driver chip 400 sets both the communication module 402 and the communication module 404 to a signal input mode to start a detection period of the detection module 800 according to some embodiments. For example, at time t₁₁, the control module 406 of the backlight driver chip 400 changes the signal 892 from a logic low level to a logic high level to close the switch 830 (e.g., to turn on the transistor 830) as shown by the waveform 992. As an example, at time t₁₁, the backlight driver chip 400 is powered on, and time t₁₁ is the start of the detection period during which the detection module 800 performs detection. In certain examples, at time t₁₁, the terminal 880 (e.g., a communication port IO) does not receive any external pull-down signal, and the voltage 896 is equal to the predetermined power supply voltage 860 as shown by the waveform 996. In some examples, at time t₁₁, the signal 894 (e.g., a detection signal) that is generated by the comparator 810 is at the logic low level, indicating the voltage 896 is higher than the reference voltage 818 (e.g., V_{ref}), as shown by the waveforms 994 and 996.

From time t₁₁ to time t₁₃, the signal 892 remains at the logic high level as shown by the waveform 992 and the switch 830 remains closed (e.g., the transistor 830 remains turned on) according to certain embodiments. For example, from time t₁₁ to time t₁₃, the voltage 896 remains higher than the reference voltage 818 (e.g., Vref_{ref}) as shown by the waveform 996. As an example, from time t₁₁ to time t₁₃, the signal 894 (e.g., a detection signal) remains at the logic low level as shown by the waveform 994. In some examples, time t₁₂ falls between time t₁₁ and time t₁₃, following time t₁₁ but preceding time t₁₃. For example, at time t₁₂, the terminal 880 (e.g., a communication port IO) receives an external pull-down signal (e.g., the external pull-down noise signal 462 or the external pull-down noise signal 472), and the voltage 896 is less than the reference voltage 818 (e.g., Vref_{ref}) but is still higher than the reference voltage 818 (e.g., Vref_{ref}) as shown by the waveform 996. As an example, at time t₁₂, the signal 894 (e.g., a detection signal) is at the logic low level as shown by the waveform 994.

At time t₁₃, the terminal 880 (e.g., a communication port IO) receives an external pull-down signal (e.g., the external pull-down signal 462 or 472, which is used to initiate normal operation of the backlight driver chip 400), and the voltage 896 starts decreasing (e.g., falling) but is still higher than the reference voltage 818 (e.g., Vref_{ref}) as shown by the waveform 996 according to some embodiments. For example, at time t₁₃, the signal 892 remains at the logic high level as shown by the waveform 992. As an example, at time t₁₃, the signal 894 (e.g., a detection signal) is still at the logic low level as shown by the waveform 994.

From time t₁₃ to time t₁₄, the terminal 880 (e.g., a communication port IO) receives the external pull-down signal (e.g., the external pull-down signal 462 or 472, which is used to initiate normal operation of the backlight driver chip 400), and the voltage 896 falls but still remains higher than the reference voltage 818 (e.g., Vref_{ref}) as shown by the waveform 996 according to certain embodiments. For example, from time t₁₃ to time t₁₄, the signal 892 remains at the logic high level as shown by the waveform 992. As an example, from time t₁₃ to time t₁₄, the signal 894 (e.g., a detection signal) remains at the logic low level as shown by the waveform 994.

At time t₁₄, the terminal 880 (e.g., a communication port IO) receives the external pull-down signal (e.g., the external pull-down signal 462 or 472, which is used to initiate normal operation of the backlight driver chip 400), and the voltage 896 becomes smaller than the reference voltage 818 (e.g., Vref_{ref}) as shown by the waveform 996 according to some embodiments. In certain examples, at time t₁₄, the signal 892 remains at the logic high level as shown by the waveform 992. In some examples, at time t₁₄, the signal 894 (e.g., a detection signal) changes from the logic low level to a logic high level as shown by the waveform 994. For example, the detection module 800 is the detection module 408, and at time t₁₄, the signal 894 (e.g., a detection signal) of the detection module 408 changes from the logic low level to the logic high level. As an example, the detection module 800 is the detection module 410, and at time t₁₄, the signal 894 (e.g., a detection signal) of the detection module 410 changes from the logic low level to the logic high level.

From time t₁₄ to time t₁₅, the terminal 880 (e.g., a communication port IO) receives the external pull-down signal (e.g., the external pull-down signal 462 or 472, which is used to initiate normal operation of the backlight driver chip 400), and the voltage 896 decreases from the reference voltage 818 (e.g., Vref_{ref}) as shown by the waveform 996 according to certain embodiments. For example, from time t₁₄ to time t₁₅, the signal 892 remains at the logic high level as shown by the waveform 992. As an example, from time t₁₄ to time t₁₅, the signal 894 (e.g., a detection signal) remains at the logic high level as shown by the waveform 994. In some examples, if at time t₁₄, the signal 894 (e.g., a detection signal) of the detection module 408 changes from the logic low level to the logic high level, the control module 406, at a time between time t₁₄ to time t₁₅, sets the configurable communication port 460 as a master communication port and the communication module 402 as a master communication module and also sets the configurable communication port 470 as a slave communication port and the communication module 404 as a slave communication module. In certain examples, if at time t₁₄, the signal 894 (e.g., a detection signal) of the detection module 410 changes from the logic low level to the logic high level, the control module 406, at a time between time t₁₄ to time t₁₅, sets the configurable communication port 470 as a master communication port and the communication module 404 as a master communication module and also sets the configurable communication port 460 as a slave communication port and the communication module 402 as a slave communication module.

At time t₁₅, the terminal 880 (e.g., a communication port IO) receives the external pull-down signal (e.g., the external pull-down signal 462 or 472, which is used to initiate normal operation of the backlight driver chip 400), and the voltage 896 reaches a predetermined low voltage level that is lower than the reference voltage 818 (e.g., Vref_{ref}) as shown by the waveform 996 according to some embodiments. In certain examples, at time t₁₅, the signal 992 changes from the logic high level to the logic low level to open the switch 830 (e.g., to turn off the transistor 830) as shown by the waveform 992. For example, time t₁₅ is the end of the detection period of the detection module 800, during which the detection module 800 performs detection. As an example, time t₁₅ is the start of normal operation of the backlight driver chip 400 that includes the detection module 800. In some examples, at time t₁₅, the signal 894 (e.g., a detection signal) remains at the logic high level as shown by the waveform 994.

After time t₁₅, the voltage 896 remains at the predetermined low voltage level that is lower than the reference voltage 818 (e.g., Vref_{ref}) as shown by the waveform 996 according to certain embodiments. In some examples, after time t₁₅, the signal 992 remains at the logic low level as shown by the waveform 992, and the switch 830 remains open (e.g., the transistor 830 remains turned off). For example, after time t₁₅, the detection module 800 does not perform detection. As an example, after time t₁₅, the backlight driver chip 400 that includes the detection module 800 undergoes normal operation. In some examples, after time t₁₅, the signal 894 (e.g., a detection signal) remains at the logic high level as shown by the waveform 994.

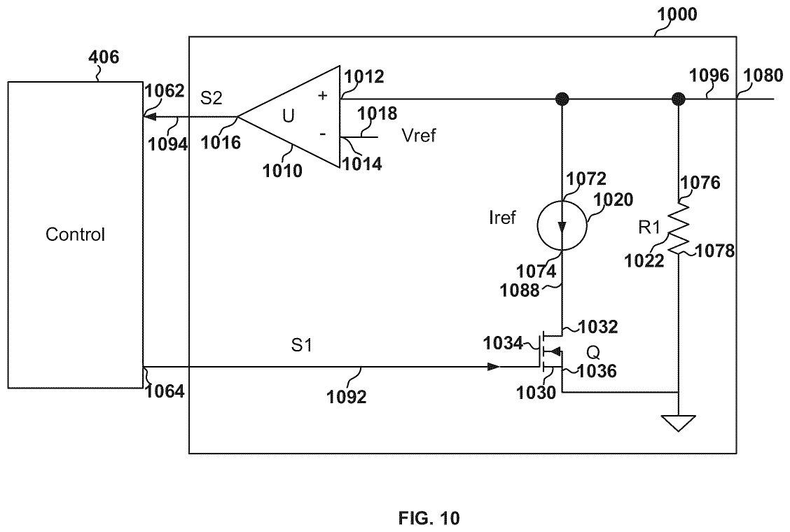

FIG. 10 is a simplified diagram showing a detection module as part of the backlight driver chip 400 as shown in FIG. 4 according to some embodiments of the present disclosure. This diagram is merely an example, which should not unduly limit the scope of the claims. One of ordinary skill in the art would recognize many variations, alternatives, and modifications. The detection module 1000 includes a terminal 1080 (e.g., a communication port IO), a comparator 1010, a current source 1020, a resistor 1022, and a switch 1030. For example, the detection module 1000 is the detection module 408, wherein the terminal 1080 is the terminal 426 connected to the configurable communication port 460. As an example, the detection module 1000 is the detection module 410, wherein the terminal 1080 is the terminal 428 connected to the configurable communication port 470. In some examples, the current source 1020 is a circuit element that serves as a port bias current source if the switch 1030 is closed. In certain examples, the switch 1030 is a transistor (e.g., an NMOS transistor). Although the above has been shown using a selected group of components for the detection module, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to certain embodiments, the resistor 1022 includes terminals 1076 and 1078, wherein the terminal 1076 is connected to the terminal 1080 (e.g., a communication port IO), and the terminal 1078 is biased to a ground voltage. In some examples, the terminal 1080 (e.g., a communication port IO) is at a voltage 1096. For example, the detection module 1000 is the detection module 408, wherein the terminal 1080 is the terminal 426, and the voltage 1096 is the voltage 464. As an example, the detection module 1000 is the detection module 410, wherein the terminal 1080 is the terminal 428, and the voltage 1096 is the voltage 474.

In some examples, the current source 1020 and the switch 1030 (e.g., a transistor) are connected in series. For example, the current source 1020 includes terminals 1072 and 1074, wherein the terminal 1072 is connected to the terminal 1080 (e.g., a communication port IO). As an example, the transistor 1030 (e.g., an NMOS transistor) includes terminals 1032, 1034, and 1036, wherein the terminal 1032 is connected to the terminal 1074 of the current source 1020, and the terminal 1036 is biased to the ground voltage. In certain examples, if the transistor 1030 (e.g., an NMOS transistor) is turned on, the current source 1020 generates a current 1088 (e.g., I_{ref}) that flows from the terminal 1072 to the terminal 1074. In some examples, the comparator 1010 includes terminals 1012, 1014, and 1016, wherein the terminal 1012 is a non-inverting input terminal, the terminal 1014 is an inverting input terminal, and the terminal 1016 is an output terminal. For example, the terminal 1012 is connected to the terminal 1080 (e.g., a communication port IO). As an example, the terminal 1014 receives a reference voltage 1018 (e.g., Vref_{ref}), which represents a predetermined threshold. For example, the reference voltage 1018 (e.g., Vref_{ref}) is higher than the ground voltage.

In some embodiments, the control module 406 includes terminals 1062 and 1064. For example, the terminal 1064 of the control module 406 outputs a signal 1092 to the terminal 1034 of the transistor 1030. As an example, the terminal 1062 of the control module 406 receives a signal 1094 (e.g., a detection signal) from the terminal 1016 of the comparator 1010, wherein the signal 1094 represents a detection result of the detection module 1000.

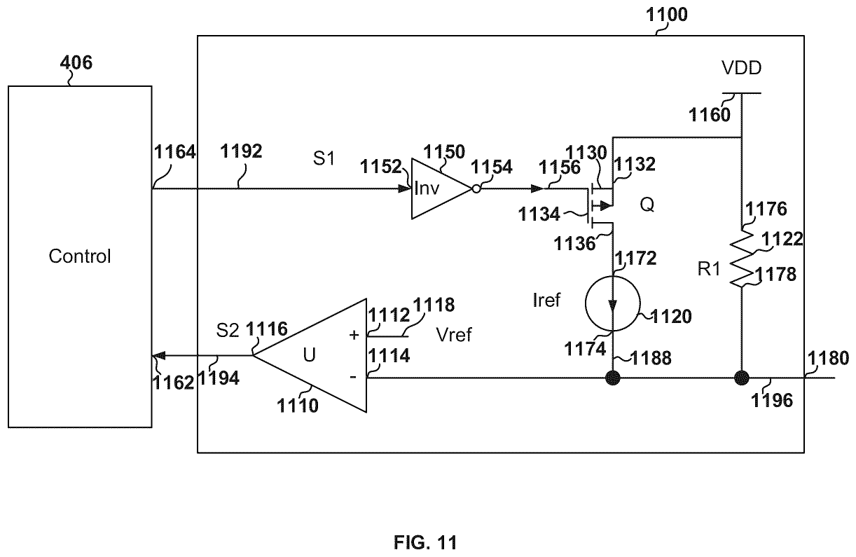

FIG. 11 is a simplified diagram showing a detection module as part of the backlight driver chip 400 as shown in FIG. 4 according to certain embodiments of the present disclosure. This diagram is merely an example, which should not unduly limit the scope of the claims. One of ordinary skill in the art would recognize many variations, alternatives, and modifications. The detection module 1100 includes a terminal 1180 (e.g., a communication port IO), a comparator 1110, a current source 1120, a resistor 1122, a switch 1130, and an inverter 1150 (e.g., a NOT gate). For example, the detection module 1100 is the detection module 408, wherein the terminal 1180 is the terminal 426 connected to the configurable communication port 460. As an example, the detection module 1100 is the detection module 410, wherein the terminal 1180 is the terminal 428 connected to the configurable communication port 470. In some examples, the current source 1120 is a circuit element that serves as a port bias current source if the switch 1130 is closed. In certain examples, the switch 1130 is a transistor (e.g., a PMOS transistor). Although the above has been shown using a selected group of components for the detection module, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to some embodiments, the resistor 1122 includes terminals 1176 and 1178, wherein the terminal 1178 is connected to the terminal 1180 (e.g., a communication port IO), and the terminal 1176 is biased to a predetermined power supply voltage 1160. In certain examples, the terminal 1180 (e.g., a communication port IO) is at a voltage 1196. For example, the detection module 1100 is the detection module 408, wherein the terminal 1180 is the terminal 426, and the voltage 1196 is the voltage 464. As an example, the detection module 1100 is the detection module 410, wherein the terminal 1180 is the terminal 428, and the voltage 1196 is the voltage 474.

In certain examples, the current source 1120 and the switch 1130 (e.g., a transistor) are connected in series. For example, the current source 1120 includes terminals 1172 and 1174, wherein the terminal 1174 is connected to the terminal 1180 (e.g., a communication port IO). As an example, the transistor 1130 (e.g., a PMOS transistor) includes terminals 1132, 1134, and 1136, wherein the terminal 1136 is connected to the terminal 1172 of the current source 1120, and the terminal 1132 is biased to the predetermined power supply voltage 1160. In some examples, if the transistor 1130 (e.g., an PMOS transistor) is turned on, the current source 1120 generates a current 1188 (e.g., I_{ref}) that flows from the terminal 1172 to the terminal 1174. In certain examples, the comparator 1110 includes terminals 1112, 1114, and 1116, wherein the terminal 1112 is a non-inverting input terminal, the terminal 1114 is an inverting input terminal, and the terminal 1116 is an output terminal. For example, the terminal 1114 is connected to the terminal 1180 (e.g., a communication port IO). As an example, the terminal 1112 receives a reference voltage 1118 (e.g., Vref_{ref}), which represents a predetermined threshold. For example, the reference voltage 1118 (e.g., Vref_{ref}) is lower than the predetermined power supply voltage 1160.

In certain embodiments, the control module 406 includes terminals 1162 and 1164, and the inverter 1150 (e.g., a NOT gate) includes an input terminal 1152 and an output terminal 1154. For example, the terminal 1164 of the control module 406 outputs a signal 1192 to the terminal 1152 of the inverter 1150 (e.g., a NOT gate), and the inverter 1150 (e.g., a NOT gate) generates a signal 1156 and outputs the signal 1156 to the terminal 1134 of the transistor 1130. As an example, the terminal 1162 of the control module 406 receives a signal 1194 (e.g., a detection signal) from the terminal 1116 of the comparator 1110, wherein the signal 1194 represents a detection result of the detection module 1100.

As shown in FIG. 6, the control module 406 controls state of the switch 630 (e.g., the switch 630 being closed or being open) by outputting the signal 692 according to certain embodiments. For example, the terminal 612 of the comparator 610 receives the voltage 696 of the terminal 680 (e.g., a communication port IO), and the terminal 614 of the comparator 610 receives the reference voltage 618 (e.g., Vref_{ref}). As an example, the terminal 616 of the comparator 610 outputs the signal 694 to the control module 406, wherein the signal 694 indicates the detection result of the detection module 600. In some examples, the detection module 600 of the backlight driver chip 400 is used for a backlight control system that uses a predetermined low voltage level (e.g., a ground voltage) before start of normal operation (e.g., before and/or during the detection period) and uses an external pull-up signal (e.g., the external pull-up signal 462 or 472) to initiate the normal operation of the backlight driver chip 400, wherein, for example, the backlight control system, according to its protocol, sets the idle voltage level of the backlight control system equal to the predetermined low voltage level (e.g., a ground voltage) before start of normal operation.

As shown in FIG. 8, the control module 406 controls state of the switch 830 (e.g., the switch 830 being closed or being open) by outputting the signal 892 to the inverter 850 (e.g., a NOT gate) according to some embodiments. For example, the terminal 814 of the comparator 810 receives the voltage 896 of the terminal 880 (e.g., a communication port IO), and the terminal 812 of the comparator 810 receives the reference voltage 818 (e.g., Vref_{ref}). As an example, the terminal 816 of the comparator 810 outputs the signal 894 to the control module 406, wherein the signal 894 indicates the detection result of the detection module 800. In certain examples, the detection module 800 of the backlight driver chip 400 is used for a backlight control system that uses a predetermined high voltage level (e.g., the predetermined power supply voltage 860) before start of normal operation (e.g., before and/or during the detection period) and uses an external pull-down signal (e.g., the external pull-down signal 462 or 472) to indicate the start of the normal operation of the backlight driver chip 400, wherein, for example, the backlight control system, according to its protocol, sets the idle voltage level of the backlight control system equal to the predetermined high voltage level (e.g., the predetermined power supply voltage 860) before start of normal operation.

As shown in FIG. 10, the current source 1020 serves as a port bias current source according to certain embodiments. For example, if the external signal 462 or 472 applied to the configurable communication port 460 or 470 has a pull-up driving capability that is higher than the current 1088, the voltage 1096 of the terminal 1080 (e.g., a communication port IO) changes. As an example, if the voltage 1096 becomes larger than the reference voltage 1018 (e.g., Vref_{ref}), the signal 1094 (e.g., a detection signal) changes from a logic low level to a logic high level. In some examples, the detection module 1000 of the backlight driver chip 400 is used for a backlight control system that uses a predetermined low voltage level (e.g., a ground voltage) before start of normal operation (e.g., before and/or during the detection period) and uses an external pull-up signal (e.g., the external pull-up signal 462 or 472) to indicate the start of the normal operation of the backlight driver chip 400, wherein, for example, the backlight control system, according to its protocol, sets the idle voltage level of the backlight control system equal to the predetermined low voltage level (e.g., a ground voltage) before start of normal operation.

As shown in FIG. 11, the current source 1120 serves as a port bias current source according to some embodiments. For example, if the external signal 462 or 472 applied to the configurable communication port 460 or 470 has a pull-down driving capability that is higher than the current 1188, the voltage 1196 of the terminal 1180 (e.g., a communication port IO) changes. As an example, if the voltage 1196 becomes smaller than the reference voltage 1118 (e.g., Vref_{ref}), the signal 1194 (e.g., a detection signal) changes from a logic low level to a logic high level. In certain examples, the detection module 1100 of the backlight driver chip 400 is used for a backlight control system that uses a predetermined high voltage level (e.g., the predetermined power supply voltage 1160) before start of normal operation (e.g., before and/or during the detection period) and uses an external pull-down signal (e.g., the external pull-down signal 462 or 472) to indicate the start of the normal operation of the backlight driver chip 400, wherein, for example, the backlight control system, according to its protocol, sets the idle voltage level of the backlight control system equal to the predetermined high voltage level (e.g., the predetermined power supply voltage 1160) before start of normal operation.

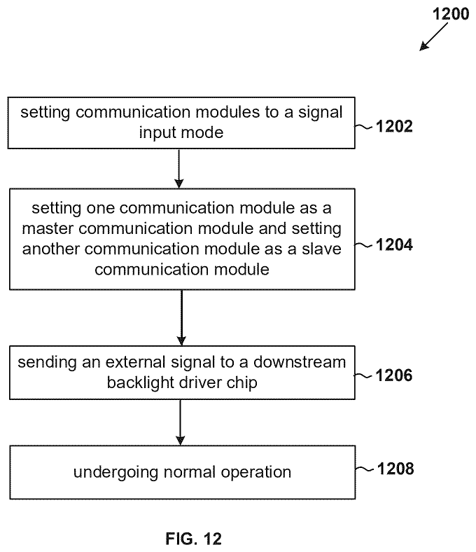

FIG. 12 is a simplified diagram showing a method for setting up the communication modules 402 and 404 of the backlight driver chip 400 with configurable communication ports as shown in FIG. 4 according to certain embodiments of the present disclosure. This diagram is merely an example, which should not unduly limit the scope of the claims. One of ordinary skill in the art would recognize many variations, alternatives, and modifications. The method 1200 includes a process 1202 for setting communication modules to a signal input mode, a process 1204 for setting one communication module as a master communication module and setting another communication module as a slave communication module, a process 1206 for sending an external signal to a downstream backlight driver chip, and a process 1208 for undergoing normal operation. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. Further details of these processes are found throughout the present specification.

At the process 1202, the backlight driver chip 400 is powered on, and the control module 406 sets the communication module 402 to the signal input mode and also sets the communication module 404 to the signal input mode according to some embodiments. For example, the configurable communication port 460 receives the external signal 462, which causes the voltage 464 to change, and the detection module 408 detects the voltage 464 and determines whether the voltage 464 changes from being smaller than a predetermined threshold to being larger than the predetermined threshold or whether the voltage 464 changes from being larger than a predetermined threshold to being smaller than the predetermined threshold. As an example, the configurable communication port 470 receives the external signal 472, which causes the voltage 474 to change, and the detection module 410 detects the voltage 474 and determines whether the voltage 474 changes from being smaller than a predetermined threshold to being larger than the predetermined threshold or whether the voltage 474 changes from being larger than a predetermined threshold to being smaller than the predetermined threshold.

At the process 1204, the control module 406 sets one communication module of communication modules 402 and 404 as a master communication module and sets the other communication module of the communication modules 402 and 404 as a slave communication module according to certain embodiments. For example, if the detection module 408 determines that the voltage 464 becomes larger than a predetermined threshold or determines that the voltage 464 becomes smaller than a predetermined threshold, the control module 406 sets the configurable communication port 460 as a master communication port and the communication module 402 as a master communication module and also sets the configurable communication port 470 as a slave communication port and the communication module 404 as a slave communication module. As an example, if the detection module 410 determines that the voltage 474 becomes larger than a predetermined threshold or determines that the voltage 474 becomes smaller than a predetermined threshold, the control module 406 sets the configurable communication port 470 as a master communication port and the communication module 404 as a master communication module and also sets the configurable communication port 460 as a slave communication port and the communication module 402 as a slave communication module.

At the process 1206, the backlight driver chip 400 sets its slave communication module to the signal output mode and uses its slave communication module to send, through its slave communication port, an external signal (e.g., an external pull-up signal or an external pull-down signal) to a configurable communication port of a downstream backlight driver chip according to some embodiments. For example, the downstream backlight driver chip uses the received external signal (e.g., an external pull-up signal or an external pull-down signal) to determine one communication module of its two communication modules to be a master communication module and the other communication module of its two communication modules to be a slave communication module.

At the process 1208, the backlight driver chip 400 undergoes normal operation according to certain embodiments. For example, during the normal operation, the backlight driver chip 400 sets its master communication module to the signal input mode and its slave communication module to the signal output mode. As an example, during the normal operation, the backlight driver chip 400 sets its master communication module to the signal output mode and its slave communication module to the signal input mode.

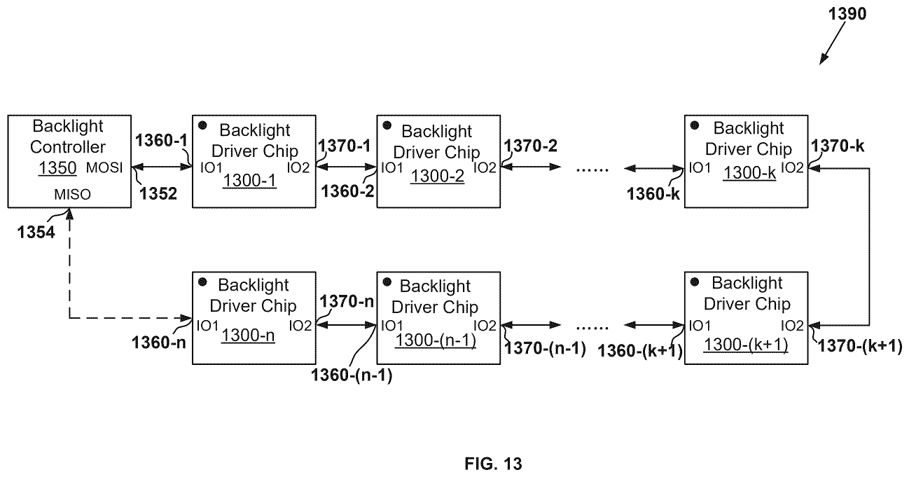

FIG. 13 is a simplified diagram showing a backlight control system for light-emitting diodes that includes multiple backlight driver chips as shown in FIG. 4 according to some embodiments of the present disclosure. This diagram is merely an example, which should not unduly limit the scope of the claims. One of ordinary skill in the art would recognize many variations, alternatives, and modifications. The backlight control system 1390 for light-emitting diodes includes a backlight controller 1350 and multiple backlight driver chips, and the multiple backlight driver chips include backlight driver chips 1300-1, 1300-2, . . . , 1300-k, . . . and 1300-n, where n is an integer greater than 1, and k is a positive integer that is smaller than n. For example, n is equal to 2. As an example, each backlight driver chip of the backlight driver chips 1300-1, 1300-2, . . . , 1300-k, . . . and 1300-n is the backlight driver chip 400 that includes the configurable communication ports 460 and 470. Although the above has been shown using a selected group of components for the backlight control system, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to certain embodiments, the backlight controller 1350 and the multiple backlight driver chips are cascaded (e.g., through a single-wire link). For example, the backlight controller 1350 includes a port 1352 (e.g., MOSI port) and a port 1354 (e.g., MISO port). In some examples, the port 1352 (e.g., MOSI port) of the backlight controller 1350 is connected to the backlight driver chip 1300-1, the backlight driver chip 1300-1 is connected to the backlight driver chip 1300-2, . . . , the backlight driver chip 1300-k is connected to the backlight driver chip 1300-(k+1), ..., and the backlight driver chip 1300-(n−1) is connected to the backlight driver chip 1300-n, where n is an integer greater than 1, and k is a positive integer that is smaller than n. For example, k is equal to 1. In certain examples, the backlight driver chip 1300-(k−1) is connected to the backlight driver chip 1300-k, and the backlight driver chip 1300-k is connected to the backlight driver chip 1300-(k+1). For example, the backlight driver chip 1300-n is connected to the port 1354 (e.g., MISO port) of the backlight controller 1350. As an example, the backlight driver chip 1300-n is not connected to the backlight controller 1350.

According to some embodiments, each backlight driver chip of the backlight driver chips 1300-1, 1300-2, . . . , 1300-k, . . . and 1300-n is the backlight driver chip 400 as shown in FIG. 4, where n is an integer greater than 1, and k is a positive integer that is smaller than n. For example, k is equal to 1. In some examples, the backlight driver chip 1300-1 includes configurable communication ports 1360-1 and 1370-1, the backlight driver chip 1300-2 includes configurable communication ports 1360-2 and 1370-2, . . . , the backlight driver chip 1300-k includes configurable communication ports 1360-k and 1370-k, the backlight driver chip 1300-(k+1) includes configurable communication ports 1360-(k+1) and 1370-(k+1), ..., and the backlight driver chip 1300-n includes configurable communication ports 1360-n and 1370-n. For example, the backlight driver chip 1300-k is the same as the backlight driver chip 400, wherein the configurable communication port 1360-k is the same as the configurable communication port 460, and the configurable communication port 1370-kis the same as the configurable communication port 470. As an example, the backlight driver chip 1300-(k+1) is the same as the backlight driver chip 400, wherein the configurable communication port 1360-(k+1) is the same as the configurable communication port 460, and the configurable communication port 1370-(k+1) is the same as the configurable communication port 470. In certain examples, k is equal to 1, . . . , or n−1.

In some embodiments, the port 1352 (e.g., MOSI port) of the backlight controller 1350 is connected to the configurable communication port 1360-1 of the backlight driver chip 1300-1, the configurable communication port 1370-1 of the backlight driver chip 1300-1 is connected to the configurable communication port 1360-2 of the backlight driver chip 1300-2, . . . , the configurable communication port 1370-k of the backlight driver chip 1300-k is connected to the configurable communication port 1370-(k+1) of the backlight driver chip 1300-(k+1), . . . , and the configurable communication port 1360-(n−1) of the backlight driver chip 1300-(n−1) is connected to the configurable communication port 1370-n of the backlight driver chip 1300-n, where n is an integer greater than 1, and k is a positive integer that is smaller than n. For example, k is equal to 1. In some examples, the configurable communication port 1370-(k−1) of the backlight driver chip 1300-(k−1) is connected to the configurable communication port 1360-k of the backlight driver chip 1300-k, and the configurable communication port 1370-k of the backlight driver chip 1300-k is connected to the configurable communication port 1370-(k+1) of the backlight driver chip 1300-(k+1). For example, the configurable communication port 1360-n of the backlight driver chip 1300-n is connected to the port 1354 (e.g., MISO port) of the backlight controller 1350 (e.g., to form a closed loop link). As an example, the configurable communication port 1360-n of the backlight driver chip 1300-n is not connected to the backlight controller 1350 (e.g., to form a unidirectional link).

According to certain embodiments, the backlight driver chip 1300-k (e.g., the backlight driver chip 400) performs the method 1200 for setting up the communication modules of the backlight driver chip 1300-k (e.g., the backlight driver chip 400) with configurable communication ports (e.g., the configurable communication ports 460 and 470). For example, the configurable communication port 460 is the same as the configurable communication port 1360-k. As an example, the configurable communication port 470 is the same as the configurable communication port 1370-k.

According to some embodiments, the backlight driver chips 1300-1, 1300-2, . . . , 1300-k, . . . and 1300-n sequentially completes its corresponding method 1200 as shown in FIG. 12. In certain examples, as part of the corresponding method 1200 for the backlight driver chip 1300-k (e.g., the backlight driver chip 400), at the process 1204, the backlight driver chip 1300-k sets the configurable communication port 1360-k as a master communication port and also sets the configurable communication port 1370-k as a slave communication port, and at the process 1206, the backlight driver chip 1300-k sends, through its slave communication port 1370-k, an external signal to the backlight driver chip 1300-(k+1). For example, the configurable communication port 1370-(k+1) of the backlight driver chip 1300-(k+1) receives the external signal from the slave communication port 1370-k of the backlight driver chip 1300-k. As an example, as part of the corresponding method 1200 for the backlight driver chip 1300-(k+1) (e.g., the backlight driver chip 400), the backlight driver chip 1300-(k+1) uses the received external signal to complete the corresponding method 1200. In some examples, as part of the corresponding method 1200 for the backlight driver chip 1300-(k+1) (e.g., the backlight driver chip 400), at the process 1204, the backlight driver chip 1300-(k+1) sets the configurable communication port 1370-(k+1) as a master communication port and also sets the configurable communication port 1360-(k+1) as a slave communication port, and at the process 1206, the backlight driver chip 1300-(k+1) sends, through its slave communication port 1360-(k+1), an external signal to the backlight driver chip 1300-(k+2).

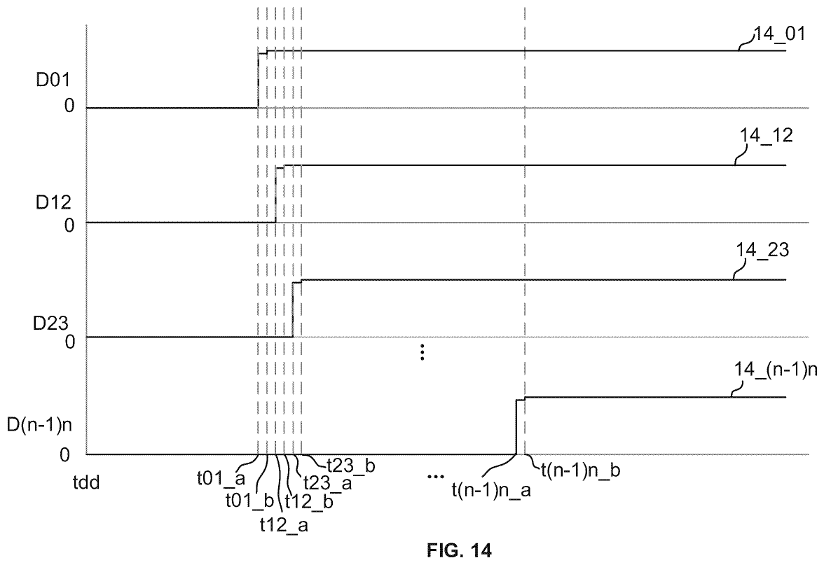

FIG. 14 shows simplified timing diagrams for the backlight control system 1390 for light-emitting diodes that includes multiple backlight driver chips as shown in FIG. 4 and FIG. 13 according to some embodiments of the present disclosure. These diagrams are merely examples, which should not unduly limit the scope of the claims. One of ordinary skill in the art would recognize many variations, alternatives, and modifications. According to certain embodiments, each backlight driver chip of the backlight control system 1390 for light-emitting diodes uses a predetermined low voltage level (e.g., a ground voltage) before start of its normal operation (e.g., before and/or during the detection period) and uses an external pull-up signal to initiate its normal operation (e.g., as shown in FIG. 6 and/or FIG. 10). The waveform 14_01 represents a signal sent from the port 1352 (e.g., MOSI port) of the backlight controller 1350 to the backlight driver chip 1300-1, the waveform 14_12 represents a signal sent from the backlight driver chip 1300-1 to the backlight driver chip 1300-2, the waveform 14_23 represents a signal sent from the backlight driver chip 1300-2 to the backlight driver chip 1300-3, . . . , and the waveform 14_(n−1)n represents a signal sent from the backlight driver chip 1300-(n−1) to the backlight driver chip 1300-n, where n is an integer greater than 1.

At time tad, the signals represented by the waveform 14_01, the waveform 14_12, the waveform 14_23, . . . , and the waveform 14_(n−1)n all are equal to the predetermined low voltage level in magnitude according to certain embodiments. For example, at time t_{dd}, the signal represented by the waveform 14_(s−1)s is equal to the predetermined low voltage level in magnitude, where s is a positive integer that is smaller than or equal to n. As an example, if the signal represented by the waveform 14_(s−1)s is equal to the predetermined low voltage level in magnitude, the backlight driver chip 1300-s does not receive any external pull-up signal. In some examples, at time t_{dd}, each backlight driver chip of the backlight control system 1390 for light-emitting diodes sets both of its communication modules (e.g., the communication module 402 and the communication module 404) to the signal input mode.

From time t_{dd} to time t_{01_a}, the signals represented by the waveform 14_01, the waveform 14_12, the waveform 14_23, . . . , and the waveform 14_(n−1)n all remain equal to the predetermined low voltage level in magnitude according to some embodiments. For example, from time t_{dd} to time t_{01_a}, the backlight driver chip 1300-1 does not receive any external pull-up signal from the port 1352 (e.g., MOSI port) of the backlight controller 1350. As an example, from time t_{dd} to time t_{01_a}, the backlight driver chip 1300-i does not receive any external pull-up signal from the backlight driver chip 1300-(i-1), where i is a positive integer that is larger than 1 and smaller than or equal to n.

At time t_{01_a}, the signal represented by the waveform 14_01 rises, but the signals represented by the waveform 14_12, the waveform 14_23, . . . , and the waveform 14_(n−1)n remain all equal to the predetermined low voltage level in magnitude according to certain embodiments. For example, at time t_{01_a}, the configurable communication ports 1360-1 of the backlight driver chip 1300-1 receives an external pull-up signal from the port 1352 (e.g., MOSI port) of the backlight controller 1350. As an example, at time t_{01_a}, the backlight driver chip 1300-i does not receive any external pull-up signal from the backlight driver chip 1300-(i-1), where i is a positive integer that is larger than 1 and smaller than or equal to n.

From time t_{01_a} to time t_{01_b}, the backlight driver chip 1300-1 uses the external pull-up signal received from the port 1352 (e.g., MOSI port) of the backlight controller 1350 to determine that the communication module connected to the configurable communication port 1360-1 is a master communication module and that the configurable communication port 1360-1 is a master communication port and also determine that the communication module connected to the configurable communication port 1370-1 is a slave communication module and that the configurable communication port 1370-1 is a slave communication port according to some embodiments. For example, from time t_{01_a} to time t_{01_b}, the signals represented by the waveform 14_12, the waveform 14_23, . . . , and the waveform 14_(n−1)n all remain equal to the predetermined low voltage level in magnitude.

At time t_{01_b}, the detection period of the backlight driver chip 1300-1 ends and the normal operation of the backlight driver chip 1300-1 starts according to certain embodiments. For example, at time t_{01_b}, the backlight driver chip 1300-1 sets its slave communication module to the signal output mode. As an example, at time t_{01_b}, the signal represented by the waveform 14_01 further increases to a predetermined operating communication level.

From time t_{01_b} to time t_{12_a}, the signal represented by the waveform 14_01 remains at the predetermined operating communication level, and the signals represented by the waveform 14_12, the waveform 14_23, . . . , and the waveform 14_(n−1)n all remain equal to the predetermined low voltage level in magnitude according to some embodiments.

At time t_{12_a}, the signal represented by the waveform 14_01 remains at the predetermined operating communication level, but the signal represented by the waveform 14_12 rises, and the signals represented by the waveform 14_23, . . . , and the waveform 14_(n−1)n all remain equal to the predetermined low voltage level in magnitude according to certain embodiments. For example, at time t_{12_a}, the configurable communication ports 1360-2 of the backlight driver chip 1300-2 receives an external pull-up signal from the configurable communication port 1360-1 of the backlight driver chip 1300-1, wherein the configurable communication port 1360-1 has been determined to be a slave communication port. As an example, at time t_{12_a}, the backlight driver chip 1300-j does not receive any external pull-up signal from the backlight driver chip 1300-(j−1), where j is a positive integer that is larger than 2 and smaller than or equal to n.

From time t_{12_a} to time t_{12_b}, the backlight driver chip 1300-2 uses the external pull-up signal received from the backlight driver chip 1300-1 to determine that the communication module connected to the configurable communication port 1360-2 is a master communication module and that the configurable communication port 1360-2 is a master communication port and also determine that the communication module connected to the configurable communication port 1370-2 is a slave communication module and that the configurable communication port 1370-2 is a slave communication port according to some embodiments. For example, from time t_{12_a} to time t_{12_b}, the signals represented by the waveform 14_23, . . . , and the waveform 14_(n−1)n all remain equal to the predetermined low voltage level in magnitude.

At time t_{12_b}, the detection period of the backlight driver chip 1300-2 ends and the normal operation of the backlight driver chip 1300-2 starts according to certain embodiments. For example, at time t_{12_b}, the backlight driver chip 1300-2 sets its slave communication module to the signal output mode. As an example, at time t_{12_b}, the signal represented by the waveform 14_12 further increases to the predetermined operating communication level.

From time t_{12_b} to time t_{23_a}, the signals represented by the waveform 14_01 and the waveform 14_12 remain at the predetermined operating communication level, and the signals represented by the waveform 14_23, . . . , and the waveform 14_(n−1)n all remain equal to the predetermined low voltage level in magnitude according to some embodiments.

At time t_{23_a}, the signals represented by the waveform 14_01 and the waveform 14_12 remain at the predetermined operating communication level, but the signal represented by the waveform 14_23 rises, and the signals represented by one or more other waveforms including the waveform 14_(n−1)n all remain equal to the predetermined low voltage level in magnitude according to certain embodiments. For example, at time t_{23_a}, the configurable communication ports 1360-3 of the backlight driver chip 1300-3 receives an external pull-up signal from the configurable communication port 1360-2 of the backlight driver chip 1300-2, wherein the configurable communication port 1360-2 has been determined to be a slave communication port. As an example, at time t_{23_a}, the backlight driver chip 1300-j does not receive any external pull-up signal from the backlight driver chip 1300-(j-1), where j is a positive integer that is larger than 3 and smaller than or equal to n.

From time t_{23_a} to time t_{23_b}, the backlight driver chip 1300-3 uses the external pull-up signal received from the backlight driver chip 1300-2 to determine that the communication module connected to the configurable communication port 1360-3 is a master communication module and that the configurable communication port 1360-3 is a master communication port and also determine that the communication module connected to the configurable communication port 1370-3 is a slave communication module and that the configurable communication port 1370-3 is a slave communication port according to some embodiments. For example, from time t_{23_a} to time t_{23_b}, the signals represented by one or more other waveforms including the waveform 14_(n−1)n all remain equal to the predetermined low voltage level in magnitude.

At time t_{23_b}, the detection period of the backlight driver chip 1300-3 ends and the normal operation of the backlight driver chip 1300-3 starts according to certain embodiments. For example, at time t_{23_b}, the backlight driver chip 1300-3 sets its slave communication module to the signal output mode. As an example, at time t_{23_b}, the signal represented by the waveform 14_23 further increases to the predetermined operating communication level.

At time t_{(n-1)n_a}, the signals represented by multiple waveforms including the waveform 14_01, the waveform 14_12, and the waveforms 14_23 remain at the predetermined operating communication level, but the signal represented by the waveform 14_(n−1)n rises according to certain embodiments. For example, at time t_{(n-1)n_a}, the configurable communication ports 1360-n of the backlight driver chip 1300-n receives an external pull-up signal from the configurable communication port 1360-(n−1) of the backlight driver chip 1300-(n−1), wherein the configurable communication port 1360-(n−1) has been determined to be a slave communication port.

From time t_{(n-1)n_a}to time t_{(n-1)n_b}, the backlight driver chip 1300-n uses the external pull-up signal received from the backlight driver chip 1300-(n−1) to determine that the communication module connected to the configurable communication port 1360-n is a master communication module and that the configurable communication port 1360-n is a master communication port and also determine that the communication module connected to the configurable communication port 1370-n is a slave communication module and that the configurable communication port 1370-n is a slave communication port according to some embodiments.

At time t_{(n-1)n_b}, the detection period of the backlight driver chip 1300-n ends and the normal operation of the backlight driver chip 1300-n starts according to certain embodiments. For example, at time t_{(n-1)n_b}, the backlight driver chip 1300-n sets its slave communication module to the signal output mode. As an example, at time t_{(n-1)n_b}, the signal represented by the waveform 14_(n−1)n further increases to the predetermined operating communication level.

After time t_{(n-1)n_b}, the entire backlight control system 1390 for light-emitting diodes undergoes normal operation according to some embodiments.

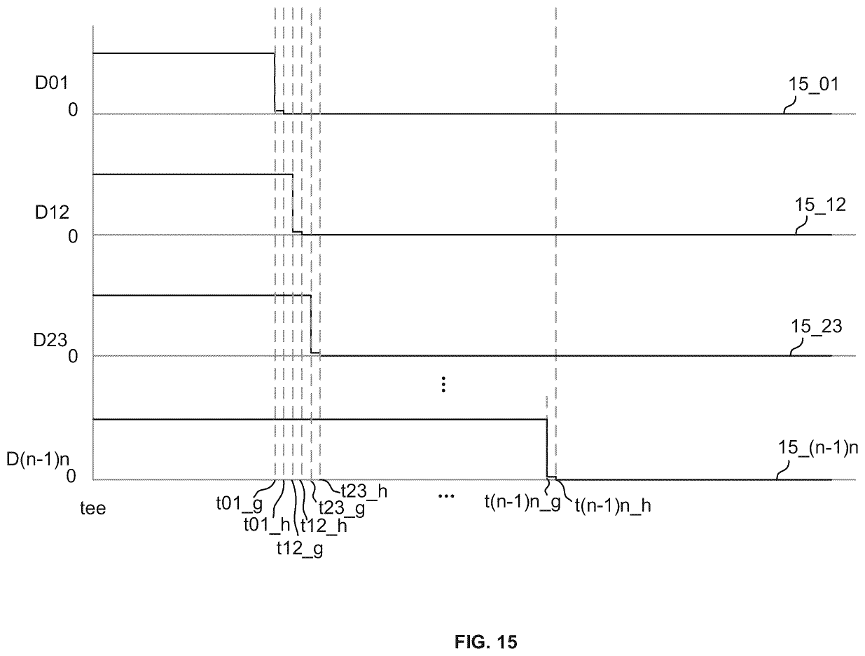

FIG. 15 shows simplified timing diagrams for the backlight control system 1390 for light-emitting diodes that includes multiple backlight driver chips as shown in FIG. 4 and FIG. 13 according to certain embodiments of the present disclosure. These diagrams are merely examples, which should not unduly limit the scope of the claims. One of ordinary skill in the art would recognize many variations, alternatives, and modifications. According to some embodiments, each backlight driver chip of the backlight control system 1390 for light-emitting diodes uses a predetermined high voltage level (e.g., the predetermined power supply voltage 860 and/or the predetermined power supply voltage 1160) before start of its normal operation (e.g., before and/or during the detection period) and uses an external pull-down signal to initiate its normal operation (e.g., as shown in FIG. 8 and/or FIG. 11). The waveform 15_01 represents a signal sent from the port 1352 (e.g., MOSI port) of the backlight controller 1350 to the backlight driver chip 1300-1, the waveform 15_12 represents a signal sent from the backlight driver chip 1300-1 to the backlight driver chip 1300-2, the waveform 15_23 represents a signal sent from the backlight driver chip 1300-2 to the backlight driver chip 1300-3, . . . , and the waveform 15_(n−1)n represents a signal sent from the backlight driver chip 1300-(n−1) to the backlight driver chip 1300-n, where n is an integer greater than 1.

At time tee, the signals represented by the waveform 15_01, the waveform 15_12, the waveform 15_23, . . . , and the waveform 15_(n−1)n all are equal to the predetermined high voltage level in magnitude according to certain embodiments. For example, at time tee, the signal represented by the waveform 15_(s−1)s is equal to the predetermined high voltage level in magnitude, where s is a positive integer that is smaller than or equal to n. As an example, if the signal represented by the waveform 15_(s−1)s is equal to the predetermined high voltage level in magnitude, the backlight driver chip 1300-s does not receive any external pull-down signal. In some examples, at time tee, each backlight driver chip of the backlight control system 1390 for light-emitting diodes sets both of its communication modules (e.g., the communication module 402 and the communication module 404) to the signal input mode.

From time tₑₑ to time t_{01_g}, the signals represented by the waveform 15_01, the waveform 15_12, the waveform 15_23, . . . , and the waveform 15_(n−1)n all remain equal to the predetermined high voltage level in magnitude according to some embodiments. For example, from time tₑₑ to time t_{01_g}, the backlight driver chip 1300-1 does not receive any external pull-down signal from the port 1352 (e.g., MOSI port) of the backlight controller 1350. As an example, from time tₑₑ to time t_{01_g}, the backlight driver chip 1300-i does not receive any external pull-down signal from the backlight driver chip 1300-(i-1), where i is a positive integer that is larger than 1 and smaller than or equal to n.

At time t_{01_g}, the signal represented by the waveform 15_01 falls, but the signals represented by the waveform 15_12, the waveform 15_23, . . . , and the waveform 15_(n−1)n all remain equal to the predetermined high voltage level in magnitude according to certain embodiments. For example, at time t_{01_g}, the configurable communication port 1360-1 of the backlight driver chip 1300-1 receives an external pull-down signal from the port 1352 (e.g., MOSI port) of the backlight controller 1350. As an example, at time t_{01_g}, the backlight driver chip 1300-i does not receive any external pull-down signal from the backlight driver chip 1300-(i-1), where i is a positive integer that is larger than 1 and smaller than or equal to n.

From time t_{01_g} to time t_{01_h}, the backlight driver chip 1300-1 uses the external pull-down signal received from the port 1352 (e.g., MOSI port) of the backlight controller 1350 to determine that the communication module connected to the configurable communication port 1360-1 is a master communication module and that the configurable communication port 1360-1 is a master communication port and also determine that the communication module connected to the configurable communication port 1370-1 is a slave communication module and that the configurable communication port 1370-1 is a slave communication port according to some embodiments. For example, from time t_{01_g} to time t_{01_h}, the signals represented by the waveform 15_12, the waveform 15_23, . . . , and the waveform 15_(n−1)n all remain equal to the predetermined high voltage level in magnitude.

At time t_{01_h}, the detection period of the backlight driver chip 1300-1 ends and the normal operation of the backlight driver chip 1300-1 starts according to certain embodiments. For example, at time t_{01_h}, the backlight driver chip 1300-1 sets its slave communication module to the signal output mode. As an example, at time t_{01_h}, the signal represented by the waveform 15_01 further decreases to a predetermined operating communication level.

From time t_{01_h} to time t_{12_g}, the signal represented by the waveform 15_01 remains at the predetermined operating communication level, and the signals represented by the waveform 15_12, the waveform 15_23, . . . , and the waveform 15_(n−1)n all remain equal to the predetermined high voltage level in magnitude according to some embodiments.

At time t_{12_g}, the signal represented by the waveform 15_01 remains at the predetermined operating communication level, but the signal represented by the waveform 15_12 falls, and the signals represented by the waveform 15_23, . . . , and the waveform 14_(n−1)n all remain equal to the predetermined high voltage level in magnitude according to certain embodiments. For example, at time t_{12_g}, the configurable communication ports 1360-2 of the backlight driver chip 1300-2 receives an external pull-down signal from the configurable communication port 1360-1 of the backlight driver chip 1300-1, wherein the configurable communication port 1360-1 has been determined to be a slave communication port. As an example, at time t_{12_g}, the backlight driver chip 1300-j does not receive any external pull-down signal from the backlight driver chip 1300-(j−1), where j is a positive integer that is larger than 2 and smaller than or equal to n.

From time t_{12_g} to time t_{12_h}, the backlight driver chip 1300-2 uses the external pull-down signal received from the backlight driver chip 1300-1 to determine that the communication module connected to the configurable communication port 1360-2 is a master communication module and that the configurable communication port 1360-2 is a master communication port and also determine that the communication module connected to the configurable communication port 1370-2 is a slave communication module and that the configurable communication port 1370-2 is a slave communication port according to some embodiments. For example, from time t_{12_g}to time t_{12_h}, the signals represented by the waveform 15_23, . . . , and the waveform 15_(n−1)n all remain equal to the predetermined high voltage level in magnitude.

At time t_{12_h}, the detection period of the backlight driver chip 1300-2 ends and the normal operation of the backlight driver chip 1300-2 starts according to certain embodiments. For example, at time t_{12_g}, the backlight driver chip 1300-2 sets its slave communication module to the signal output mode. As an example, at time t_{12_g}, the signal represented by the waveform 15_12 further decreases to the predetermined operating communication level.

From time t_{12_h}to time t_{23_g}, the signals represented by the waveform 15_01 and the waveform 15_12 remain at the predetermined operating communication level, and the signals represented by the waveform 15_23, . . . , and the waveform 15_(n−1)n all remain equal to the predetermined high voltage level in magnitude according to some embodiments.

At time t_{23_g}, the signals represented by the waveform 15_01 and the waveform 15_12 remain at the predetermined operating communication level, but the signal represented by the waveform 15_23 falls, and the signals represented by one or more other waveforms including the waveform 15_(n−1)n all remain equal to the predetermined high voltage level in magnitude according to certain embodiments. For example, at time t_{12_g}, the configurable communication ports 1360-3 of the backlight driver chip 1300-3 receives an external pull-down signal from the configurable communication port 1360-2 of the backlight driver chip 1300-2, wherein the configurable communication port 1360-2 has been determined to be a slave communication port. As an example, at time t_{23_g}, the backlight driver chip 1300-j does not receive any external pull-down signal from the backlight driver chip 1300-(j−1), where j is a positive integer that is larger than 3 and smaller than or equal to n.

From time t_{23_g}to time t_{23_h}, the backlight driver chip 1300-3 uses the external pull-down signal received from the backlight driver chip 1300-2 to determine that the communication module connected to the configurable communication port 1360-3 is a master communication module and that the configurable communication port 1360-3 is a master communication port and also determine that the communication module connected to the configurable communication port 1370-3 is a slave communication module and that the configurable communication port 1370-3 is a slave communication port according to some embodiments. For example, from time t_{23_g}to time t_{23_h}, the signals represented by one or more other waveforms including the waveform 15_(n−1)n all remain equal to the predetermined high voltage level in magnitude.

At time t_{23_h}, the detection period of the backlight driver chip 1300-3 ends and the normal operation of the backlight driver chip 1300-3 starts according to certain embodiments. For example, at time t_{23_h}, the backlight driver chip 1300-3 sets its slave communication module to the signal output mode. As an example, at time t_{23_h}, the signal represented by the waveform 14 23 further decreases to the predetermined operating communication level.

At time t_{(n-1)n_g}, the signals represented by multiple waveforms including the waveform 15_01, the waveform 15_12, and the waveforms 15_23 remain at the predetermined operating communication level, but the signal represented by the waveform 15_(n−1)n falls according to certain embodiments. For example, at time t_{(n-1)n_g}, the configurable communication ports 1360-n of the backlight driver chip 1300-n receives an external pull-down signal from the configurable communication port 1360-(n-1) of the backlight driver chip 1300-(n-1), wherein the configurable communication port 1360-(n-1) has been determined to be a slave communication port.

From time t_{(n-1)n_g}to time t_{(n-1)n_h}, the backlight driver chip 1300-n uses the external pull-down signal received from the backlight driver chip 1300-(n−1) to determine that the communication module connected to the configurable communication port 1360-n is a master communication module and that the configurable communication port 1360-n is a master communication port and also determine that the communication module connected to the configurable communication port 1370-n is a slave communication module and that the configurable communication port 1370-n is a slave communication port according to some embodiments.

At time t_{(n-1)n_h}, the detection period of the backlight driver chip 1300-n ends and the normal operation of the backlight driver chip 1300-n starts according to certain embodiments. For example, at time t_{(n-1)n_h}, the backlight driver chip 1300-n sets its slave communication module to the signal output mode. As an example, at time t_{(n-1)n_h}, the signal represented by the waveform 15_(n−1)n further decreases to the predetermined operating communication level.

After time t_{(n-1)n_h}, the entire backlight control system 1390 for light-emitting diodes undergoes normal operation according to some embodiments.

As shown in at least FIG. 4, FIG. 6, FIG. 8, FIG. 10, FIG. 11, and/or FIG. 13, the control module 406 is configured to control a switch (e.g., the switch 630, the switch 830, the switch 1030, and/or the switch 1130) in the detection module 408 and/or the detection module 410 so that the switch (e.g., the switch 630, the switch 830, the switch 1030, and/or the switch 1130) changes from being closed to being open and/or changes from being open to being closed according to certain embodiments. For example, after the control module 406 decides one communication module of the backlight driver chip 400 to be a master communication module and the other communication module of the backlight driver chip 400 to be a slave communication module, the switch in the detection module 408 changes from being closed to being open, and the switch in the detection module 410 also changes from being closed to being open, so that the configurable communication ports 460 and 470 are not affected by, for example, the resistor 620, the resistor 820, the current source 1020 and/or the current source 1120. As an example, when the configurable communication ports 460 and 470 are not affected by the resistor 620, the resistor 820, the current source 1020 and/or the current source 1120, the control module 406 can, via its corresponding master communication module and/or its corresponding slave communication module, communicate normally with a backlight controller (e.g., the backlight controller 1350) and/or one or more other backlight driver chips in a backlight control system for light-emitting diodes (e.g., the backlight control system 1390).

In some embodiments, as shown in at least FIG. 4 and/or FIG. 13, for the backlight driver chip 400, during normal operation, if the one communication module that has been designated as the master communication module is set to a signal input mode and if the other communication module that has been designated as the slave communication module is set to a signal output mode, the backlight driver chip 400 (e.g., the control module 406) receives, through its master communication module, a control signal from a backlight controller (e.g., the port 1352 of the backlight controller 1350) or from its immediate upstream backlight driver chip, and the backlight driver chip 400 (e.g., the control module 406) also generates another control signal based at least in part on the received control signal, and sends, through its slave communication module, the another control signal to its immediate downstream backlight driver chip if the backlight driver chip 400 is not the most downstream driver chip of a backlight control system (e.g., the backlight control system 1390).

In certain embodiments, as shown in at least FIG. 4 and/or FIG. 13, for the backlight driver chip 400, during normal operation, if the one communication module that has been designated as the master communication module is set to a signal output mode and if the other communication module that has been designated as the slave communication module is set to a signal input mode, the backlight driver chip 400 (e.g., the control module 406) receives, through its slave communication module, a feedback signal from its immediate downstream backlight driver chip if the backlight driver chip 400 is not the most downstream driver chip of a backlight control system (e.g., the backlight control system 1390), and the backlight driver chip 400 (e.g., the control module 406) also generates another feedback signal based at least in part on the received feedback signal, and sends, through its master communication module, the another feedback signal to a backlight controller (e.g., the port 1352 of the backlight controller 1350) or to its immediate upstream backlight driver chip.

According to some embodiments, the present disclosure provides a backlight control system for light-emitting diodes (e.g., the backlight control system 1390) that includes multiple backlight driver chips. In certain examples, each backlight driver chip (e.g., the backlight driver chip 400) of the multiple backlight driver chips includes two communication modules of identical circuit structures (e.g., the communication modules 402 and 404) and two corresponding configurable communication ports (e.g., the configurable communication port 460 that corresponds to the communication module 402 and the configurable communication port 470 that corresponds to the communication module 404). In certain examples, each communication module of the two communication modules (e.g., the communication modules 402 and 404) is not predetermined to be a master communication module or to be a slave communication module, and each configurable communication port of the two configurable communication ports (e.g., the configurable communication ports 460 and 470) is not predetermined to be a master communication port or to be a slave communication port. In some examples, one configurable communication port (e.g., the configurable communication port 460) of a backlight driver chip (e.g., the backlight driver chip 400) is connected to another backlight driver chip in a backlight control system (e.g., the backlight control system 1390), wherein after the connection, if the backlight driver chip (e.g., the backlight driver chip 400) determines that the another backlight driver chip is an immediate upstream backlight driver chip, the backlight driver chip (e.g., the backlight driver chip 400) designates the configurable communication port (e.g., the configurable communication port 460) as a master communication port and also designates a corresponding communication module (e.g., the communication module 404 that corresponds to the configurable communication port 460) as a master communication module, and if the backlight driver chip (e.g., the backlight driver chip 400) determines that the another backlight driver chip is an immediate downstream backlight driver chip, the backlight driver chip (e.g., the backlight driver chip 400) designates the configurable communication port (e.g., the configurable communication port 460) as a slave communication port and also designates the corresponding communication module (e.g., the communication module 404 that corresponds to the configurable communication port 460) as a slave communication module.

According to certain embodiments, the present disclosure provides a backlight driver chip (e.g., the backlight driver chip 400) that includes two communication modules (e.g., the communication modules 402 and 404) and two corresponding configurable communication ports (e.g., the configurable communication port 460 that corresponds to the communication module 402 and the configurable communication port 470 that corresponds to the communication module 404), wherein one communication module (e.g., the communication module 402) is available for being used as both a master communication module and a slave communication module, and its corresponding configurable communication port (e.g., the configurable communication port 460 that corresponds to the communication module 402) is available for being used as both a master communication port and a slave communication port). In some examples, during wiring of multiple backlight driver chips for a backlight control system for light-emitting diodes (e.g., the backlight control system 1390), there is no need to rotate the orientation of one or more conventional backlight driver chips, change one or more wiring methods, and/or add one or more additional jumper wires, so the wiring costs are significantly reduced.

According to some embodiments, a backlight driver chip for a backlight control system for light-emitting diodes includes: a first configurable communication port at a first voltage; a second configurable communication port at a second voltage; a first communication module connected to the first configurable communication port; a second communication module connected to the second configurable communication port; a first detection module connected to the first configurable communication port; a second detection module connected to the second configurable communication port; and a control module connected to the first communication module, the second communication module, the first detection module, and the second detection module; wherein: the first detection module is configured to determine whether the first voltage becomes larger than a first predetermined threshold or whether the first voltage becomes smaller than a second predetermined threshold to generate a first detection signal; and the second detection module is configured to determine whether the second voltage becomes larger than the first predetermined threshold or whether the second voltage becomes smaller than the second predetermined threshold to generate a second detection signal; wherein the control module is configured to: receive the first detection signal and the second detection signal; and determine one communication module of the first communication module and the second communication module to be a master communication module and the other communication module of the first communication module and the second communication module to be a slave communication module based at least in part on the first detection signal and the second detection signal. For example, the backlight driver chip is implemented according to at least FIG. 4.

As an example, if the first communication module is determined to be the master communication module and the second communication module is determined to be the slave communication module, the first configurable communication port is a master communication port and the second configurable communication port is a slave communication port. For example, if the first communication module is determined to be the slave communication module and the second communication module is determined to be the master communication module, the first configurable communication port is a slave communication port and the second configurable communication port is a master communication port. As an example, the control module is further configured to: if the first detection signal indicates that the first voltage becomes larger than the first predetermined threshold, determine the first communication module to be the master communication module and the second communication module to be the slave communication module; and if the second detection signal indicates that the second voltage becomes larger than the first predetermined threshold, determine the second communication module to be the master communication module and the first communication module to be the slave communication module.

For example, the control module is further configured to: if the first detection signal indicates that the first voltage becomes smaller than the second predetermined threshold, determine the first communication module to be the master communication module and the second communication module to be the slave communication module; and if the second detection signal indicates that the second voltage becomes smaller than the second predetermined threshold, determine the second communication module to be the master communication module and the first communication module to be the slave communication module. As an example, the control module is further configured to: set the first communication module to a signal input mode; and set the second communication module to the signal input mode. For example, the first configurable communication port is configured to receive an external pull-up signal to cause the first voltage to rise to become larger than the first predetermined threshold. As an example, the second configurable communication port is configured to receive an external pull-up signal to cause the second voltage to rise to become larger than the first predetermined threshold. For example, the first configurable communication port is configured to receive an external pull-down signal to cause the first voltage to fall to become smaller than the second predetermined threshold. As an example, the second configurable communication port is configured to receive an external pull-down signal to cause the second voltage to fall to become smaller than the second predetermined threshold.

For example, the first communication module includes: a signal output path connected between the first configurable communication port and the control module; and a signal input path connected between the first configurable communication port and the control module; and the control module is configured to: enable the signal output path to set the first communication module to a signal output mode; and disable the signal output path to set the first communication module to a signal input mode. As an example, the first detection module includes: a first resistor biased between the first voltage and a predetermined voltage; a switch and a circuit element connected in series between the first voltage and the predetermined voltage; and a comparator configured to receive the first voltage and the first predetermined threshold and generate the first detection signal; wherein the first predetermined threshold is higher than the predetermined voltage. For example, the predetermined voltage is a ground voltage. As an example, the circuit element is a second resistor. For example, the circuit element is a current source. As an example, the first detection module is further configured to, if the switch is closed, in response to the first voltage becoming larger than the first predetermined threshold, change the first detection signal from a first logic level to a second logic level.

For example, the first detection module includes: a first resistor biased between the first voltage and a predetermined voltage; a switch and a circuit element connected in series between the first voltage and the predetermined voltage; and a comparator configured to receive the first voltage and the second predetermined threshold and generate the first detection signal; wherein the second predetermined threshold is lower than the predetermined voltage. As an example, the predetermined voltage is a power supply voltage. For example, the circuit element is a second resistor. As an example, the circuit element is a current source. For example, the first detection module is further configured to, if the switch is closed, in response to the first voltage becoming smaller than the second predetermined threshold, change the first detection signal from a first logic level to a second logic level.

As an example, the control module is further configured to: set the master communication module to a signal input mode; and set the slave communication module to a signal output mode. For example, the control module is further configured to: set the master communication module to a signal output mode; and set the slave communication module to a signal input mode.

According to certain embodiments, a method for a backlight driver chip, the method comprising: setting a first communication module to a signal input mode, the first communication module being connected to a first configurable communication port at a first voltage; setting a second communication module to the signal input mode, the second communication module being connected to a second configurable communication port at a second voltage; determining whether the first voltage becomes larger than a predetermined threshold to generate a first detection signal; determining whether the second voltage becomes larger than the predetermined threshold to generate a second detection signal; receiving the first detection signal and the second detection signal; determining the first communication module to be a master communication module and the second communication module to be a slave communication module if the first detection signal indicates that the first voltage becomes larger than the predetermined threshold; and determining the second communication module to be the master communication module and the first communication module to be the slave communication module if the second detection signal indicates that the second voltage becomes larger than the predetermined threshold. For example, the method is implemented according to at least FIG. 4.

As an example, the method further includes: receiving an external pull-up signal to cause the first voltage to rise to become larger than the predetermined threshold; and in response to the first voltage becoming larger than the predetermined threshold, changing the first detection signal from a first logic level to a second logic level. For example, the method further includes: receiving an external pull-up signal to cause the second voltage to rise to become larger than the predetermined threshold; and in response to the second voltage becoming larger than the predetermined threshold, changing the second detection signal from a first logic level to a second logic level.

According to some embodiments, a method for a backlight driver chip, the method comprising: setting a first communication module to a signal input mode, the first communication module being connected to a first configurable communication port at a first voltage; setting a second communication module to the signal input mode, the second communication module being connected to a second configurable communication port at a second voltage; determining whether the first voltage becomes smaller than a predetermined threshold to generate a first detection signal; determining whether the second voltage becomes smaller than the predetermined threshold to generate a second detection signal; receiving the first detection signal and the second detection signal; determining the first communication module to be a master communication module and the second communication module to be a slave communication module if the first detection signal indicates that the first voltage becomes smaller than the predetermined threshold; and determining the second communication module to be the master communication module and the first communication module to be the slave communication module if the second detection signal indicates that the second voltage becomes smaller than the predetermined threshold. For example, the method is implemented according to at least FIG. 4.

As an example, the method further includes: receiving an external pull-down signal to cause the first voltage to fall to become smaller than the predetermined threshold; and in response to the first voltage becoming smaller than the predetermined threshold, changing the first detection signal from a first logic level to a second logic level. For example, the method further includes: receiving an external pull-down signal to cause the second voltage to fall to become smaller than the predetermined threshold; and in response to the second voltage becoming smaller than the predetermined threshold, changing the second detection signal from a first logic level to a second logic level.

According to certain embodiments, a backlight control system for light-emitting diodes includes: a backlight controller including a first controller port and a second controller port; a first backlight driver chip including a first configurable communication port at a first voltage and a second configurable communication port at a second voltage; and a second backlight driver chip including a third configurable communication port at a third voltage and a fourth configurable communication port at a fourth voltage; wherein: the first controller port is connected to the first configurable communication port of the first backlight driver chip; and the second configurable communication port of the first backlight driver chip is connected to the third configurable communication port of the second backlight driver chip; wherein the first backlight driver chip is configured to: receive, at the first configurable communication port, a first external pull-up signal to cause the first voltage to rise; determine whether the first voltage becomes larger than a predetermined threshold; if the first voltage becomes larger than the predetermined threshold, determine the first configurable communication port to be a first master communication port and the second configurable communication port to be a first slave communication port; and output, at the second configurable communication port, a second external pull-up signal; wherein the second backlight driver chip is configured to: receive, at the third configurable communication port, the second external pull-up signal to cause the third voltage to rise; determine whether the third voltage becomes larger than the predetermined threshold; and if the third voltage becomes larger than the predetermined threshold, determine the third configurable communication port to be a second master communication port and the fourth configurable communication port to be a second slave communication port. For example, the backlight control system is implemented according to at least FIG. 13 and/or FIG. 4.

As an example, the first backlight driver chip further includes: a first communication module connected to the first configurable communication port; a second communication module connected to the second configurable communication port; a first detection module connected to the first configurable communication port; a second detection module connected to the second configurable communication port; and a control module connected to the first communication module, the second communication module, the first detection module, and the second detection module. For example, the first detection module is configured to determine whether the first voltage becomes larger than the predetermined threshold to generate a first detection signal; and the second detection module is configured to determine whether the second voltage becomes larger than the predetermined threshold to generate a second detection signal. As an example, the control module is configured to: receive the first detection signal and the second detection signal; and determine one configurable communication port of the first configurable communication port and the second configurable communication port to be the first master communication port and the other configurable communication port of the first configurable communication port and the second configurable communication port to be the first slave communication port based at least in part on the first detection signal or the second detection signal.

For example, the control module is configured to, before receiving the first external pull-up signal at the first configurable communication port, set the first communication module to a signal input mode; and set the second communication module to the signal input mode. As an example, the first configurable communication port is configured to receive the first external pull-up signal to cause the first voltage to rise from a predetermined voltage and become larger than the predetermined threshold. For example, the predetermined voltage is a ground voltage lower than the predetermined threshold. As an example, the control module is configured to, before outputting the second external pull-up signal at the second configurable communication port, set the second communication module to a signal output mode.

For example, the second backlight driver chip is configured to output, at the fourth configurable communication port, a third external pull-up signal. As an example, the fourth configurable communication port is connected to a fifth configurable communication port of a third backlight driver chip; and the fifth configurable communication port is configured to receive the third external pull-up signal. For example, the fourth configurable communication port is connected to the second controller port of the backlight controller.

According to some embodiments, a backlight control system for light-emitting diodes includes: a backlight controller including a first controller port and a second controller port; a first backlight driver chip including a first configurable communication port at a first voltage and a second configurable communication port at a second voltage; and a second backlight driver chip including a third configurable communication port at a third voltage and a fourth configurable communication port at a fourth voltage; wherein: the first controller port is connected to the first configurable communication port of the first backlight driver chip; and the second configurable communication port of the first backlight driver chip is connected to the third configurable communication port of the second backlight driver chip; wherein the first backlight driver chip is configured to: receive, at the first configurable communication port, a first external pull-down signal to cause the first voltage to fall; determine whether the first voltage becomes smaller than a predetermined threshold; if the first voltage becomes smaller than the predetermined threshold, determine the first configurable communication port to be a first master communication port and the second configurable communication port to be a first slave communication port; and output, at the second configurable communication port, a second external pull-down signal; wherein the second backlight driver chip is configured to: receive, at the third configurable communication port, the second external pull-down signal to cause the third voltage to fall; determine whether the third voltage becomes smaller than the predetermined threshold; and if the third voltage becomes smaller than the predetermined threshold, determine the third configurable communication port to be a second master communication port and the fourth configurable communication port to be a second slave communication port. For example, the backlight control system is implemented according to at least FIG. 13 and/or FIG. 4.

As an example, the first backlight driver chip further includes: a first communication module connected to the first configurable communication port; a second communication module connected to the second configurable communication port; a first detection module connected to the first configurable communication port; a second detection module connected to the second configurable communication port; and a control module connected to the first communication module, the second communication module, the first detection module, and the second detection module. For example, the first detection module is configured to determine whether the first voltage becomes smaller than the predetermined threshold to generate a first detection signal; and the second detection module is configured to determine whether the second voltage becomes smaller than the predetermined threshold to generate a second detection signal. As an example, the control module is configured to: receive the first detection signal and the second detection signal; and determine one configurable communication port of the first configurable communication port and the second configurable communication port to be the first master communication port and the other configurable communication port of the first configurable communication port and the second configurable communication port to be the first slave communication port based at least in part on the first detection signal or the second detection signal.

For example, the control module is configured to, before receiving the first external pull-down signal at the first configurable communication port, set the first communication module to a signal input mode; and set the second communication module to the signal input mode. As an example, the first configurable communication port is configured to receive the first external pull-down signal to cause the first voltage to fall from a predetermined voltage and become smaller than the predetermined threshold. For example, the predetermined voltage is a power supply voltage higher than the predetermined threshold. As an example, the control module is configured to, before outputting the second external pull-down signal at the second configurable communication port, set the second communication module to a signal output mode.

For example, the second backlight driver chip is configured to output, at the fourth configurable communication port, a third external pull-down signal. As an example, the fourth configurable communication port is connected to a fifth configurable communication port of a third backlight driver chip; and the fifth configurable communication port is configured to receive the third external pull-down signal. For example, the fourth configurable communication port is connected to the second controller port of the backlight controller.

According to certain embodiments, a method for a backlight control system for light-emitting diodes, the backlight control system including a backlight controller including a first controller port and a second controller port, a first backlight driver chip including a first configurable communication port and a second configurable communication port, and a second backlight driver chip including a third configurable communication port and a fourth configurable communication port, the first controller port being connected to the first configurable communication port, the second configurable communication port being connected to the third configurable communication port, the method comprising: receiving, at the first configurable communication port, a first external pull-up signal to cause a first voltage of the first configurable communication port to rise; determining whether the first voltage becomes larger than a predetermined threshold; if the first voltage becomes larger than the predetermined threshold, determining the first configurable communication port to be a first master communication port and the second configurable communication port to be a first slave communication port; and outputting, at the second configurable communication port, a second external pull-up signal; receiving, at the third configurable communication port, the second external pull-up signal to cause a second voltage of the third configurable communication port to rise; determining whether the second voltage becomes larger than the predetermined threshold; and if the second voltage becomes larger than the predetermined threshold, determining the third configurable communication port to be a second master communication port and the fourth configurable communication port to be a second slave communication port. For example, the method is implemented according to at least FIG. 13 and/or FIG. 4.

According to some embodiments, a method for a backlight control system for light-emitting diodes, the backlight control system including a backlight controller including a first controller port and a second controller port, a first backlight driver chip including a first configurable communication port and a second configurable communication port, and a second backlight driver chip including a third configurable communication port and a fourth configurable communication port, the first controller port being connected to the first configurable communication port, the second configurable communication port being connected to the third configurable communication port, the method comprising: receiving, at the first configurable communication port, a first external pull-down signal to cause a first voltage of the first configurable communication port to fall; determining whether the first voltage becomes smaller than a predetermined threshold; if the first voltage becomes smaller than the predetermined threshold, determining the first configurable communication port to be a first master communication port and the second configurable communication port to be a first slave communication port; and outputting, at the second configurable communication port, a second external pull-down signal; receiving, at the third configurable communication port, the second external pull-down signal to cause a second voltage of the third configurable communication port to fall; determining whether the second voltage becomes smaller than the predetermined threshold; and if the second voltage becomes smaller than the predetermined threshold, determining the third configurable communication port to be a second master communication port and the fourth configurable communication port to be a second slave communication port. For example, the method is implemented according to at least FIG. 13 and/or FIG. 4.

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, various embodiments and/or examples of the present disclosure can be combined.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments.

1.-29. (canceled)

30. A backlight control system for light-emitting diodes, the system comprising:
a backlight controller including a first controller port and a second controller port;
a first backlight driver chip including a first configurable communication port at a first voltage and a second configurable communication port at a second voltage; and
a second backlight driver chip including a third configurable communication port at a third voltage and a fourth configurable communication port at a fourth voltage;
wherein:
the first controller port is connected to the first configurable communication port of the first backlight driver chip; and
the second configurable communication port of the first backlight driver chip is connected to the third configurable communication port of the second backlight driver chip;
wherein the first backlight driver chip is configured to:
receive, at the first configurable communication port, a first external pull-up signal to cause the first voltage to rise;
determine whether the first voltage becomes larger than a predetermined threshold;
if the first voltage becomes larger than the predetermined threshold, determine the first configurable communication port to be a first master communication port and the second configurable communication port to be a first slave communication port; and
output, at the second configurable communication port, a second external pull-up signal;
wherein the second backlight driver chip is configured to:
receive, at the third configurable communication port, the second external pull-up signal to cause the third voltage to rise;
determine whether the third voltage becomes larger than the predetermined threshold; and
if the third voltage becomes larger than the predetermined threshold, determine the third configurable communication port to be a second master communication port and the fourth configurable communication port to be a second slave communication port.

31. The backlight control system of claim 30 wherein the first backlight driver chip further includes:
a first communication module connected to the first configurable communication port;
a second communication module connected to the second configurable communication port;
a first detection module connected to the first configurable communication port;
a second detection module connected to the second configurable communication port; and
a control module connected to the first communication module, the second communication module, the first detection module, and the second detection module.

32. The backlight control system of claim 31 wherein:
the first detection module is configured to determine whether the first voltage becomes larger than the predetermined threshold to generate a first detection signal; and
the second detection module is configured to determine whether the second voltage becomes larger than the predetermined threshold to generate a second detection signal.

33. The backlight control system of claim 32 wherein the control module is configured to:
receive the first detection signal and the second detection signal; and
determine one configurable communication port of the first configurable communication port and the second configurable communication port to be the first master communication port and the other configurable communication port of the first configurable communication port and the second configurable communication port to be the first slave communication port based at least in part on the first detection signal or the second detection signal.

34. The backlight control system of claim 31 wherein the control module is configured to, before receiving the first external pull-up signal at the first configurable communication port,
set the first communication module to a signal input mode; and
set the second communication module to the signal input mode.

35. The backlight control system of claim 34 wherein the first configurable communication port is configured to receive the first external pull-up signal to cause the first voltage to rise from a predetermined voltage and become larger than the predetermined threshold.

36. The backlight control system of claim 35 wherein the predetermined voltage is a ground voltage lower than the predetermined threshold.

37. The backlight control system of claim 31 wherein the control module is configured to, before outputting the second external pull-up signal at the second configurable communication port, set the second communication module to a signal output mode.

38. The backlight control system of claim 30 wherein the second backlight driver chip is configured to output, at the fourth configurable communication port, a third external pull-up signal.

39. The backlight control system of claim 38 wherein:
the fourth configurable communication port is connected to a fifth configurable communication port of a third backlight driver chip; and
the fifth configurable communication port is configured to receive the third external pull-up signal.

40. The backlight control system of claim 30 wherein the fourth configurable communication port is connected to the second controller port of the backlight controller.

41. A backlight control system for light-emitting diodes, the system comprising:
a backlight controller including a first controller port and a second controller port;
a first backlight driver chip including a first configurable communication port at a first voltage and a second configurable communication port at a second voltage; and
a second backlight driver chip including a third configurable communication port at a third voltage and a fourth configurable communication port at a fourth voltage;
wherein:
the first controller port is connected to the first configurable communication port of the first backlight driver chip; and
the second configurable communication port of the first backlight driver chip is connected to the third configurable communication port of the second backlight driver chip;
wherein the first backlight driver chip is configured to:
receive, at the first configurable communication port, a first external pull-down signal to cause the first voltage to fall;
determine whether the first voltage becomes smaller than a predetermined threshold;
if the first voltage becomes smaller than the predetermined threshold, determine the first configurable communication port to be a first master communication port and the second configurable communication port to be a first slave communication port; and
output, at the second configurable communication port, a second external pull-down signal;
wherein the second backlight driver chip is configured to:
receive, at the third configurable communication port, the second external pull-down signal to cause the third voltage to fall;
determine whether the third voltage becomes smaller than the predetermined threshold; and
if the third voltage becomes smaller than the predetermined threshold, determine the third configurable communication port to be a second master communication port and the fourth configurable communication port to be a second slave communication port.

42. The backlight control system of claim 41 wherein the first backlight driver chip further includes:
a first communication module connected to the first configurable communication port;
a second communication module connected to the second configurable communication port;
a first detection module connected to the first configurable communication port;
a second detection module connected to the second configurable communication port; and
a control module connected to the first communication module, the second communication module, the first detection module, and the second detection module.

43. The backlight control system of claim 42 wherein:
the first detection module is configured to determine whether the first voltage becomes smaller than the predetermined threshold to generate a first detection signal; and
the second detection module is configured to determine whether the second voltage becomes smaller than the predetermined threshold to generate a second detection signal.

44. The backlight control system of claim 43 wherein the control module is configured to:
receive the first detection signal and the second detection signal; and
determine one configurable communication port of the first configurable communication port and the second configurable communication port to be the first master communication port and the other configurable communication port of the first configurable communication port and the second configurable communication port to be the first slave communication port based at least in part on the first detection signal or the second detection signal.

45. The backlight control system of claim 42 wherein the control module is configured to, before receiving the first external pull-down signal at the first configurable communication port,
set the first communication module to a signal input mode; and
set the second communication module to the signal input mode.

46. The backlight control system of claim 45 wherein the first configurable communication port is configured to receive the first external pull-down signal to cause the first voltage to fall from a predetermined voltage and become smaller than the predetermined threshold.

47. The backlight control system of claim 46 wherein the predetermined voltage is a power supply voltage higher than the predetermined threshold.

48. The backlight control system of claim 42 wherein the control module is configured to, before outputting the second external pull-down signal at the second configurable communication port, set the second communication module to a signal output mode.

49. The backlight control system of claim 41 wherein the second backlight driver chip is configured to output, at the fourth configurable communication port, a third external pull-down signal.

50. The backlight control system of claim 49 wherein:
the fourth configurable communication port is connected to a fifth configurable communication port of a third backlight driver chip; and
the fifth configurable communication port is configured to receive the third external pull-down signal.

51. The backlight control system of claim 41 wherein the fourth configurable communication port is connected to the second controller port of the backlight controller.

52. A method for a backlight control system for light-emitting diodes, the backlight control system including a backlight controller including a first controller port and a second controller port, a first backlight driver chip including a first configurable communication port and a second configurable communication port, and a second backlight driver chip including a third configurable communication port and a fourth configurable communication port, the first controller port being connected to the first configurable communication port, the second configurable communication port being connected to the third configurable communication port, the method comprising:
receiving, at the first configurable communication port, a first external pull-up signal to cause a first voltage of the first configurable communication port to rise;
determining whether the first voltage becomes larger than a predetermined threshold;
if the first voltage becomes larger than the predetermined threshold, determining the first configurable communication port to be a first master communication port and the second configurable communication port to be a first slave communication port; and
outputting, at the second configurable communication port, a second external pull-up signal;
receiving, at the third configurable communication port, the second external pull-up signal to cause a second voltage of the third configurable communication port to rise;
determining whether the second voltage becomes larger than the predetermined threshold; and
if the second voltage becomes larger than the predetermined threshold, determining the third configurable communication port to be a second master communication port and the fourth configurable communication port to be a second slave communication port.

53. A method for a backlight control system for light-emitting diodes, the backlight control system including a backlight controller including a first controller port and a second controller port, a first backlight driver chip including a first configurable communication port and a second configurable communication port, and a second backlight driver chip including a third configurable communication port and a fourth configurable communication port, the first controller port being connected to the first configurable communication port, the second configurable communication port being connected to the third configurable communication port, the method comprising:
receiving, at the first configurable communication port, a first external pull-down signal to cause a first voltage of the first configurable communication port to fall;
determining whether the first voltage becomes smaller than a predetermined threshold;
if the first voltage becomes smaller than the predetermined threshold, determining the first configurable communication port to be a first master communication port and the second configurable communication port to be a first slave communication port; and
outputting, at the second configurable communication port, a second external pull-down signal;
receiving, at the third configurable communication port, the second external pull-down signal to cause a second voltage of the third configurable communication port to fall;
determining whether the second voltage becomes smaller than the predetermined threshold; and
if the second voltage becomes smaller than the predetermined threshold, determining the third configurable communication port to be a second master communication port and the fourth configurable communication port to be a second slave communication port.
